(19) United States
(12) Patent Application Publication
(10) Pub. No.: US 2025/0296717 A1
(43) Pub. Date: Sep. 25, 2025

(54) SYSTEMS AND METHODS FOR HANDLING ITEMS

(71) Applicant: Fulfil Solutions, Inc., Mountain View, CA (US)

(72) Inventors: Jason Kalus, Oakland, CA (US); Arni Lehto, Pittsburgh, PA (US); Brock Csira, Saratoga, CA (US); Gilad Almogy, Palo Alto, CA (US)

(21) Appl. No.: 19/203,806

(22) Filed: May 9, 2025

Related U.S. Application Data
(63) Continuation of application No. 18/149,353, filed on Sep. 21, 2023.
Application No. 18/149,353 is a continuation of application No. PCT/US21/39687, filed on Jun. 29, 2021.
(60) Provisional application No. 63/046,242, filed on Jun. 30, 2020.

(51) Int. Cl. B65B 43/54; B65B 5/08; B65B 35/12; B65B 43/26

(52) U.S. Cl. CPC B65B 43/54; B65B 5/08; B65B 35/12; B65B 43/26

(57) ABSTRACT

The present disclosure provides systems and methods for handling items. A method may comprise transporting an item using a conveyance unit in a first direction to or towards a support, and placing the item onto or into the support by retracting the conveyance unit in a second direction that is different from the first direction when the item reaches a desired location relative to the support. Another method may comprise providing a container, placing an item into or onto the container, and extending or elongating the container in a direction so as to form an enclosure surrounding the item.

### CROSS-REFERENCE TO RELATED APPLICATIONS

This application is a continuation application of U.S. application Ser. No. 18/149,353, filed on 21-SEP-2023, which is a continuation application of International Patent Application PCT/US2021/039687, filed Jun. 29, 2021, which claims the benefit of U.S. Provisional Application No. 63/046,242 filed Jun. 30, 2020, each of which is incorporated in its entirety by this reference.

### BACKGROUND

Efficient handling of many different types of items that exhibit a variety of shapes and/or sizes, can pose an increasingly complex technological challenge. For example, produce items alone offered by a conventional grocery store, may exhibit sizes ranging from that of a raisin to that of a watermelon. Moreover, the quality of such produce items can degrade over time, affecting their monetary value.

### SUMMARY

Product handling systems according to embodiments facilitate transfer of individual product items from incoming bulk form into dedicated trays for subsequent inspection, sorting, selection, and packaging for consumption. Inspection may comprise interrogation of product items within a tray by electromagnetic (e.g., optical, hyperspectral) or other (e.g., physical, acoustic, gas sensing, etc.) techniques. Prior to packaging, product items disposed within the tray may be stored in a system that is responsible for controlling environmental factors such as temperature, humidity, illumination, ambient gases, product-to-product interactions, and/or others. Movement of product items from a system's transfer station may be accomplished using robots and/or conveyor belts. Embodiments may allow rapid, low-cost consumer selection of specific individual product items based upon their accompanying metadata (e.g., source, identifier), in combination with the results of inspection (e.g., visual appearance). Some embodiments may receive product items that are already pre-packaged in tray format in order to expedite inspection, sorting, selection, and packaging.

In some embodiments, the present disclosure provides a product handling system.

In some embodiments, the present disclosure provides a method of handling an item. In some embodiments, the method of handling an item comprises: transporting said item using a conveyance unit in a first direction to or towards a support; and placing said item onto or into said support by retracting said conveyance unit in a second direction that is different from said first direction when said item reaches a desired location relative to said support.

In some embodiments, said first direction and said second direction are opposite to each other. In some embodiments, said item is placed onto or into said support by concurrently or simultaneously transporting said item in said first direction and retracting said conveyance unit in said second direction. In some embodiments, said item is placed onto or into said support in-situ at or near said desired location. In some embodiments, said item is placed onto or into said support by sliding or gliding onto or into said support.

In some embodiments, the method further comprises controlling a positioning or orientation of each of said conveyance unit and said support, to minimize a drop height or distance of said item onto or into said support. In some embodiments, said item is transported in said first direction using a conveyor belt or rail system. In some embodiments, said conveyance unit is retracted as a whole in said second direction.

In some embodiments, the method comprises moving a conveyor belt or rail system on said conveyance unit at a first speed in said first direction and moving said conveyance unit as a whole at a second speed in said second direction, upon said item reaching said desired location relative to said support. In some embodiments, said first speed and said second speed are substantially the same. In some embodiments, said first speed and said second speed are different. In some embodiments, said conveyance unit is located above said support when said item reaches said desired location relative to said support.

In some embodiments, the method further comprises moving said conveyance unit such that a portion of said conveyance unit is inserted into or penetrates said support when said item reaches said desired location relative to said support. In some embodiments, said support is a flat surface. In some embodiments, support is horizontally leveled. In some embodiments, said support is inclined. In some embodiments, said support comprises an angled, sloped or beveled surface. In some embodiments, said support comprises a flexible material. In some embodiments, said support comprises brushes or bushings. In some embodiments, said brushes or bushings are flexible. In some embodiments, wherein a portion of said conveyance unit is inserted through said brushes or bushings when said item reaches said desired location relative to said support. In some embodiments, said support comprises one or more grooves or channels. In some embodiments, a portion of said conveyance unit is located adjacent to said one or more grooves or channels when said item reaches said desired location relative to said support. In some embodiments, placing said item onto or into said support comprises resting said item onto said one or more grooves or channels as said conveyance unit is being retracted in said second direction.

In some embodiments, the method of handling an item comprises: providing a container, which container comprises one or more compartments; placing said item into or onto said one or more compartments of said container; and extending or elongating said container in a direction so as to form an enclosure surrounding said item.

In some embodiments, a size or shape of said container changes as said container is extended or elongated in said direction. In some embodiments, an internal volume of said container changes as said container is extended or elongated in said direction. In some embodiments, said internal volume increases as said container is extended or elongated in said direction.

In some embodiments, said enclosure provides support or protection to said item. In some embodiments, said enclosure conforms to a shape or size of said item. In some embodiments, said item is placed into or onto said container by dropping under influence of gravity. In some embodiments, said item is placed into or onto said container by falling in another direction that is different from said direction in which said container is extended or elongated. In some embodiments, said direction and said another direction are opposite to each other.

In some embodiments, said container comprises a flexible or stretchable material. In some embodiments, said container is extended or elongated by translating a distal portion of said container in said direction. In some embodiments, said container is extended or elongated along a longitudinal axis of said container.

In some embodiments, direction is opposite to a direction of gravitational force. In some embodiments, said container is extended or elongated in said direction when said item is dropped into or onto said container. In some embodiments, said direction is along a direction of gravitational force. In some embodiments, a weight of said item causes said container to extend or elongate in said direction. In some embodiments, a weight of said item results in said enclosure being formed and surrounding said item.

In some embodiments, said one or more compartments are collapsible and/or expandable. In some embodiments, said one or more compartments comprises a flexible or stretchable material. In some embodiments, extending or elongating said container in said direction comprises expanding or stretching said one or more compartments.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1A, FIG. 1B, FIG. 1C, FIG. 2, FIG. 3, and FIG. 4 schematically illustrate a dispensing mechanism for product handling and dispensing, in accordance with some embodiments.

FIG. 5A, FIG. 5B, FIG. 6A, FIG. 6B, FIG. 7, FIG. 8, and FIG. 9 schematically illustrate a brush surface dispensing mechanism for product handling and dispensing, in accordance with some embodiments.

FIG. 10, FIG. 11, FIG. 12, FIG. 13, and FIG. 14 schematically illustrate a charging system for an automated guided vehicle (AGV), in accordance with some embodiments.

FIG. 15, FIG. 16, and FIG. 17 schematically illustrate an item container, in accordance with some embodiments.

FIG. 18-FIG. 40 schematically illustrate various mechanisms for conveyor to conveyor item transfers, in accordance with some embodiments.

FIG. 41 schematically illustrates a system for sanitizing conveyor belts, in accordance with some embodiments.

FIG. 42-FIG. 49 schematically illustrate a metal tray design with customizable lane spacings, in accordance with some embodiments.

FIG. 50 schematically illustrates a tray component for variable tray support heights, in accordance with some embodiments.

FIG. 51 schematically illustrates a tray with cavities to receive a built-in phase change material, in accordance with some embodiments.

FIG. 52 schematically illustrates a multiple tray storage unit, in accordance with some embodiments.

FIG. 53 schematically illustrates a multiple depth tray storage unit, in accordance with some embodiments.

FIG. 54 and FIG. 55 schematically illustrate trays that may be configured to couple together, in accordance with some embodiments.

FIG. 56 and FIG. 57 schematically illustrate a system for ultraviolet (UV) tray sanitization, in accordance with some embodiments.

FIG. 58 schematically illustrates an AGV, in accordance with some embodiments.

FIG. 59 and FIG. 60 schematically illustrate a bag capture mechanism, in accordance with some embodiments.

FIG. 61, FIG. 62, and FIG. 63 schematically illustrate a tool for automatically putting a bag into an item container, in accordance with some embodiments.

FIG. 64 schematically illustrates a thermally enclosed item container, in accordance with some embodiments.

FIG. 65 and FIG. 66 schematically illustrate a top cover for a thermally enclosed item container, in accordance with some embodiments.

FIG. 67 schematically illustrates a multi compartment collapsible bag, in accordance with some embodiments.

FIG. 68 schematically illustrates a method of reorganizing items in a bag, in accordance with some embodiments.

FIG. 69 schematically illustrates a bag handle retention and ejection mechanism, in accordance with some embodiments.

FIG. 70 and FIG. 71 schematically illustrate a temporary temperature-controlled storage of bags before pickup, in accordance with some embodiments.

FIG. 72 and FIG. 73 schematically illustrate an automated guided vehicle (AGV) that is configured to hold multiple boxes at the same time, in accordance with some embodiments.

FIG. 74-FIG. 79 schematically illustrate a system for manually loading items into inventory to interface with an automated storage system, in accordance with some embodiments.

FIG. 80 schematically illustrates a lightbox below a tray to aid in tray filling, in accordance with some embodiments.

FIG. 81-FIG. 84 schematically illustrate a pre-induction storage system, in accordance with some embodiments.

FIG. 85 schematically illustrates an insulation panel with built-in phase change materials, in accordance with some embodiments.

FIG. 86 and FIG. 87 schematically illustrate an integrated environmental control system, in accordance with some embodiments.

FIG. 88 and FIG. 89 schematically illustrate a robotic mechanism for transporting items from a conveyor to a bag, in accordance with some embodiments.

FIG. 90, FIG. 91, FIG. 92, and FIG. 93 schematically illustrate a slide into bag mechanism, in accordance with some embodiments.

FIG. 94, FIG. 95, FIG. 96, FIG. 97, and FIG. 98 schematically illustrate an item dispense and bag handoff mechanism, in accordance with some embodiments.

FIG. 99 and FIG. 100 schematically illustrate a mechanism for weighing objects on a conveyor belt, in accordance with some embodiments.

FIG. 101 schematically illustrates a computer system configured to implement the methods of the present disclosure, in accordance with some embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “item” or “product” as used herein generally refers to food or non-food items or products. Such food or non-food items or products may be accessible by consumers or available to consumers at a grocery store, convenience store, supermarket, food wholesaler, or food distributor. The food items can include, for example, fresh produce (e.g., fruits, vegetables, etc.), dairy products, meat products, grains, snacks, beverages, food condiments, herbs, spices, seasonings, prepared foods, frozen foods, and/or any type of food item that is contained with a packaging. Non-food items can include, for example, cookware, kitchenware, cooking utensils, eating utensils, cooking tools, kitchen appliances, cutlery, any devices or apparatuses that can be used to prepare, eat, package, or store food items, and/or any type of non-food item that is contained with a packaging. Non-food items or products may include consumer goods, electronics, devices, parts, components, systems, and items of any scale or complexity (including finished goods, unfinished or partially manufactured goods, raw materials, etc.), such as those items or products that may be found in warehouses, fulfilment/stocking/packaging centers, shipping docks, air logistics hubs, manufacturing plants, supply chain distribution points, etc.

The term “real-time,” as used herein, generally refers to a simultaneous or substantially simultaneous occurrence of a first event or action with respect to an occurrence of a second event or action. A real-time action or event may be performed within a response time of less than one or more of the following: ten seconds, five seconds, one second, a tenth of a second, a hundredth of a second, a millisecond, or less relative to at least another event or action. A real-time action may be performed by one or more computer processors.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The terms “a,” “an,” and “the,” as used herein, generally refer to singular and plural references unless the context clearly dictates otherwise.

### Overview

In an aspect, the present disclosure provides systems and methods for product handling, storage, and dispensing. The systems and methods of the present disclosure may be implemented to enable efficient handling and dispensing of items in a controlled manner while minimizing excessive unintended movement of such items, thereby reducing a risk of damaging or improperly handling the items (e.g., from induction of items to storage of such items to dispensing of the items into containers for distribution to consumers). The systems and methods of the present disclosure may further enable efficient storage of items to maximize packing density while providing convenient access to any stored items. The systems and methods of the present disclosure may also permit the storage of temperature-sensitive items at one or more desired temperatures to maintain the cold chain of items for optimal freshness for consumer consumption. The systems and methods of the present disclosure may further enable efficient packing of items into containers or bags that are configured to deploy into a configuration that enables consistent and reliable capture of any food or non-food items and products as defined or described herein. The systems and methods of the present disclosure may further enable the storage of items in modular trays that are designed to be customizable in shape, size, and/or function such that a singular tray design can be used to store a variety of different food or non-food items having different shapes and/or sizes. In addition, the systems and methods of the present disclosure may provide mechanisms to facilitate the transportation or conveyance of items and products across a plurality of conveyors placed in series while maximizing item throughput success and minimizing a chance of items and products getting stuck between gaps, spaces, or divots between conveyors.

### Item Orientation

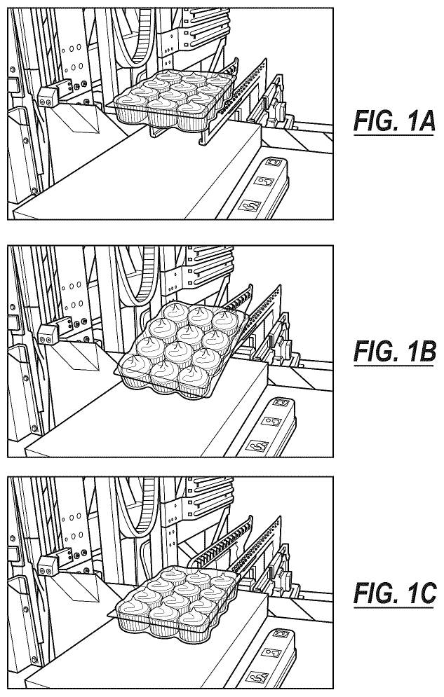

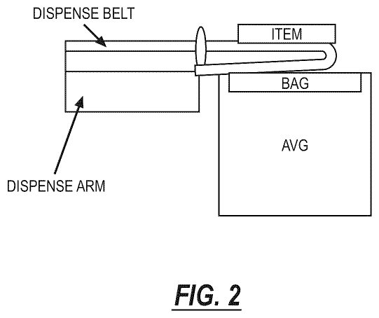

FIG. 1A, FIG. 1B, and FIG. 1C illustrate a dispense mechanism for laying an item on a surface. The dispense mechanism may be configured to convey the item forward while the dispense mechanism translates backwards relative to the surface such that the item is laid flat on the surface. The dispense mechanism can be configured to convey an item such that the item remains in a proper or desired orientation during the conveyance. The desired or proper orientation may be an upright orientation, such that there is a reduced risk of damaged to the items or spillage. The desired or proper orientation may refer to an orientation used for efficient packing. FIG. 2, FIG. 3, and FIG. 4 schematically illustrates the dispense mechanism for product handling and dispensing. A red dot is illustrated in FIG. 2, FIG. 3, and FIG. 4 as a reference point indicating a direction of belt rotation and item movement/conveyance. The dispense mechanism may comprise a dispense belt that is configured to move an item (e.g., packaged chicken) forwards towards a bag. The bag may be disposed on an item container of a robot or automated guided vehicle (AGV) bearing a collapsible bag on top (e.g., for receiving a plurality of product items). The AVG may be configured to move between various locations (e.g., from a first location where items are being dispensed to a second location where the dispensed items are stored for pick up by a customer or a delivery courier). The AVG can comprise a support surface on which items and products can be placed or held for transport to different regions in a warehouse, a grocery store, or an item storage, handling, packing, and distribution center. The support surface may comprise a horizontal support surface that is located on an upper portion of the AVG. The support surface may be integrated with one or more structural components of the AVG. The AVG can be configured to hold or support a container (e.g., a box or a bag) in which a plurality of items and products can be placed or held. In some cases, the container may be optional (i.e., the items and products can be placed directly on a support surface of the AVG). Items and products may rest on a supporting structure or surface of the AVG. The dispense belt may be operatively coupled to a dispense arm. The dispense arm may be configured to retract backwards at a first speed while moving the dispense belt forward at a second speed. The first speed and the second speed may be substantially the same. In such cases, the item on the dispense arm does not move relative to the ground, which results in zero horizontal velocity of the item such that it falls straight down into a bag or platform of the AVG. This is in contrast to other traditional modes of dispensing items that do not utilize a retracting dispense arm, where the item is “pushed” off the end of the arms with a horizontal velocity. The value of such a system is the ability to dispense items on to a static or unactuated platform without changing item orientation. This system also allows controlled dispensing and fulfilment of items that are sensitive to orientation (e.g. items with leaky tops) or items that would be damaged by being dropped on its side (e.g., eggs or other fragile goods in a clamshell packaging). In some cases, the first speed at which the dispense arm retracts backward and the second speed at which the dispense belt moves an item or product forward may be different. In some cases, the first speed may be greater than the second speed. Alternatively, the first speed may be less than the second speed. The first speed and the second speed may differ by at least about 1%, 2%, 3%, 4%, 5%, 6%, 7%, 8%, 9%, 10%, or more. The first speed and the second speed may differ by at most about 10%, 9%, 8%, 7%, 6%, 5%, 4%, 3%, 2%, 1%, or less. In some embodiments, the dispense arm and/or the dispense belt may be provided at an angle relative to the bag or platform of the AVG. The angle between a top edge of the bag or platform and the dispense arm and/or dispense belt on which the items are being conveyed may be at least about 5 degrees, 10 degrees, 15 degrees, 20 degrees, 25 degrees, 30 degrees, 35 degrees, 40 degrees, 45 degrees, 50 degrees, 55 degrees, 60 degrees, or more. As an item is conveyed downwards on the angled dispense arm and/or dispense belt, frictional forces between a surface of the item and a surface of the dispense belt may hold the item in place so that the item does not inadvertently fall or roll off dispense belt.

In some cases, the dispense arm and the dispense belt may be configured to convey one or more items onto a surface or a structure comprising a groove. The groove may comprise a V-shaped or U-shaped groove on which the one or more items may rest. The V-shaped or U-shaped groove may be configured to contact the dispensed item at two or more points such that the item is positioned and/or oriented in a stable configuration. The V-shaped or U-shaped groove may be sized and/or shaped to accommodate a plurality of different items with different sizes and/or shapes.

### Dispensing Mechanism and Brush Surface

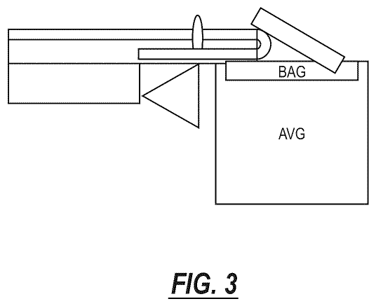

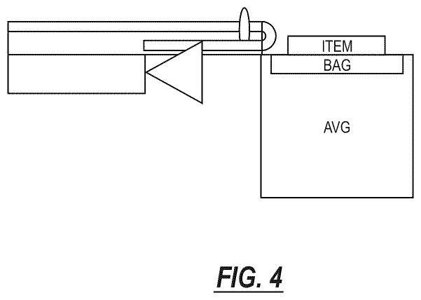

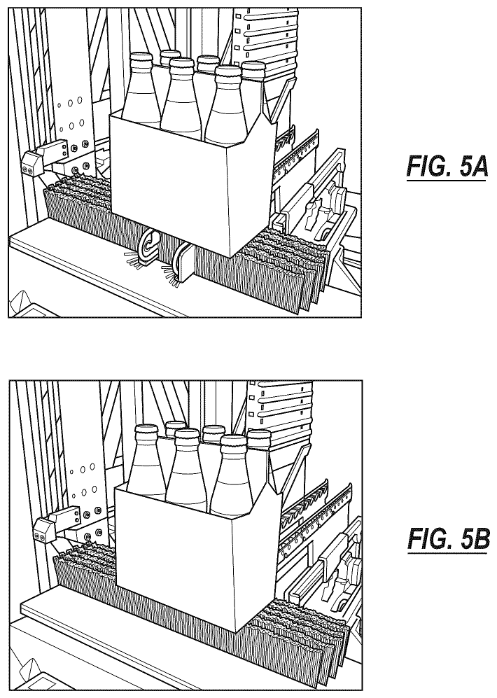

FIG. 5A, FIG. 5B, FIG. 6A, and FIG. 6B illustrate a dispense mechanism for laying an item on a brush surface for product handling and dispensing, in accordance with some embodiments. FIG. 7, FIG. 8, and FIG. 9 schematically illustrate a dispense mechanism for laying an item on a brush surface for product handling and dispensing. The dispense mechanism may operate in a similar manner to the dispense mechanism illustrated in FIG. 1A, FIG. 1B, FIG. 1C, FIG. 2, FIG. 3, and FIG. 4, but the dispense arm may be configured to extend into and retract out from a material comprising one or more channels, or a flexible material (e.g., brushes or any other material that can provide vertical support for items and products) that allow the arms to pass through spaces or gaps between the flexible material. The flexible material may be configured to reduce a drop height of the one or more items conveyed along a dispense belt that extends along a length of the dispense arm. In some cases, the dispense arm and/or the dispense belt may be provided at a predetermined height such that one or more items conveyed by the dispense belt are dispensed directly onto a surface of the flexible material. In other cases, the dispense arm and/or the dispense belt may be provided at a height such that one or more items conveyed by the dispense belt are positioned above the flexible material. In such cases, the dispense arm and/or dispense belt may be configured to move downwards after the dispense arm is in an extended position over a portion of the flexible material so that the items on the dispense belt are placed on top of the flexible material. Afterwards, the dispense arm and/or dispense belt may move upwards and/or retract backwards away from the flexible material. The upward and backward motions of the dispense arm and/or dispense belt may occur simultaneously, or may occur at different times (i.e., the dispense arm and/or dispense belt may move backwards first before moving upwards or may move upwards first before moving backwards). The height and/or length of brushes or flexible material may permit the dispense arm to pass through the brushes or flexible material in some cases or extend above the brushes or flexible material in other cases. As described above, in some cases the dispense arm may move into the brushes or flexible material and move downwards to place the items on the brushes or flexible material. The dispense arm can then move backwards or retract backwards. In some cases, the dispense arm can move or extend into and out of the brushes or flexible material and place the items on the brushes or flexible material without requiring a separate downward motion.

In some cases, the brushes or flexible material described above may be replaced with one or more grooves or channels. In such cases, the dispense arms may be configured to extend, move, or translate through the grooves or channels and place the items or products being conveyed along the dispense belt onto or into the grooves or channels. The grooves or channels may be formed using various structural components such as, for example, vertical support structures, pillars, plates, rods, and/or beams. The various structural components may be interspaced or physically separated by a predetermined separation distance to accommodate an item or product that is placed on or between the structural components. The one or more grooves or channels may be configured to hold items and products with a plurality of different shapes, sizes, and/or dimensions. The one or more grooves or channels can provide a plurality of kinematic contact points on which various items and products can rest in a stable configuration. The kinematic points may kinematically constrain the position and/or the orientation of the items or products placed into or onto the grooves or channels. In some cases, the kinematic contact points may comprise at least two or more contact points. In some cases, the dispense arm may undergo a series of motions to place items and products onto or into the grooves or channels. For example, the dispense arms may be configured to extend through, into, or between a groove or channel such that item is positioned above at least a portion of the groove or channel. The dispense arms may then move downwards so that item or product initially positioned on the dispense arm or dispense belt is placed in contact with at least a portion of the groove or channel. The item or product may then rest on the groove or channel, or a portion thereof, while contacting the groove or channel at two or more contact points, and the dispense arm may retract backwards and away from the item or product placed on the groove or channel. In some cases, after the dispense arm retracts backwards, the dispense arm may move upwards to return to a predetermined height.

In some cases, the one or more channels or grooves may comprise a V-shaped or U-shaped groove on which the one or more items may rest. The V-shaped or U-shaped groove may be configured to contact the dispensed item at two or more points such that the item is positioned and/or oriented in a stable configuration. The V-shaped or U-shaped groove may be sized and/or shaped to accommodate a plurality of different items with different sizes and/or shapes.

### Charging

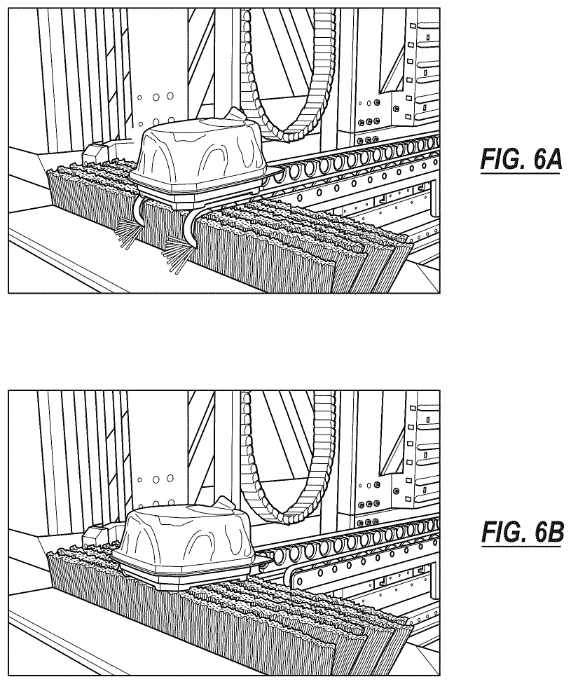

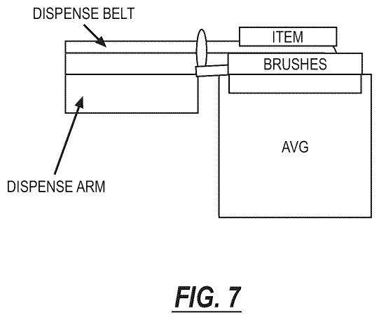

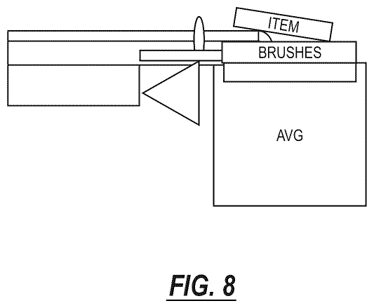

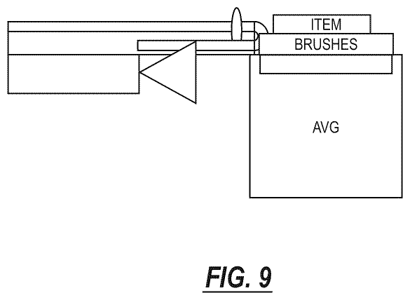

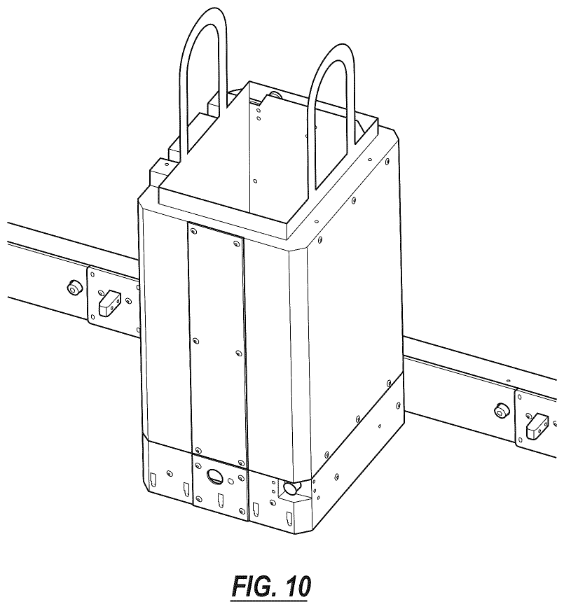

FIG. 10, FIG. 11, FIG. 12, FIG. 13, and FIG. 14 schematically illustrate a charging system for an automated guided vehicle (AGV), in accordance with some embodiments. The charging system may be affixed to a floor or a surface on which an automated guided vehicle can drive into to initiate charging of one or more batteries integrated in the automated guided vehicle. The charging system may comprise a charging station side with one or more probes. The one or more probes may comprise a first set of electrical contacts on opposing faces of the one or more probes. The one or more probes may interface with a socket that is disposed on a surface of the automated guided vehicle. The socket of the automated guided vehicle may comprise a second set of electrical contacts on opposing inner surfaces of the socket. The first set of electrical contacts may contact the second set of electrical contacts to initiate a current or flow of electricity from the charging station to the AGV to enable charging. In some cases, the AGV may have a socket with three or more degrees of freedom. In some cases, the socket may have freely articulating contacts with five or more degrees of freedom. In some cases, the probe and/or the socket may comprise a self-aligning mechanism with multiple degrees of freedom. Such a charging system may enable one or more AGVs to recharge their batteries in an automated fashion. The AGVs may be configured to move towards the charging system when a battery level reaches a predetermined level (e.g., less than 50% battery). The AGVs may be configured to adjust their positions and/or an orientations relative to the charging station to enable interfacing of the probe of the charger and a socket of the AGVs.

### Item Containers

FIG. 15, FIG. 16, and FIG. 17 schematically illustrate an item container, in accordance with some embodiments. The item container may be a bag. The item container may comprise a bag of smaller volume or a mini bag. A mini bag may be used to store similar items. One or more mini bags filled with items may be deposited into an item container. The item container may comprise or be made of a flexible material such as fabric or plastic. The systems and methods of the present disclosure may be implemented in combination with one or more item containers or bags. The item containers may comprise multiple compartments. The one or more item containers may comprise one or more physical dividers to divide up an open bag area into a plurality of smaller compartments. In some cases, the plurality of smaller compartments may comprise at least two, three, four, five, six, or more smaller compartments. In some cases, one or more of the smaller compartments may be configured to store different types of items or products (e.g. a first compartment may be configured to store produce, and a second compartment may be configured to store non-perishable items).

Items and products may be placed in or dispensed into the item containers as described above. As shown in FIG. 16, in some cases, the upper edges of the bag may be secured to a rigid structure or semi-rigid structure (e.g., a rim) that extends around a perimeter of the bag opening. The bag may initially be provided in an undeployed configuration whereby the opening of the bag is exposed and the remaining volume of the bag is not fully expanded or extended. In some cases, the bag may be positioned on a substantially flat surface while in the undeployed configuration. After an item is placed within the opening of the bag, the edges of the bag or the rim attached to the edges of the bag may be lifted up to fully bag the item. Such a bottom-to-top approach may help to reduce or minimize impact forces during dispensing and packaging of items by placing the items into the opening of the bag when the bag is in an undeployed configuration and performing a lifting motion to create or fully deploy a bag that surrounds the item. As shown in FIG. 17, in some cases, the bag may be in a partially deployed state whereby the opening of the bag is exposed and the remaining volume of the bag is partially expanded or extended. When an item is dispensed into the opening of the bag, the remaining volume of the bag may deploy and capture the item as the item is being dispensed. The shape of the bag may cushion the item while the item is being dispensed, and the shape of the bag (or a bottom portion of the bag) may conform to the shape of the item. In some cases, the rim of the bag or the bag itself may be lifted upwards while the item is being dispensed in order to fully deploy the bag for item capture, and to minimize impact forces when the item contacts the bag.

In some cases, the item containers may comprise a frame that holds produce bags and snaps on to the top of a robot (e.g., an automated guided vehicle). The bags may be held by passive or active mechanisms. The passive mechanism may comprise flexible “jaws” that hold on to one or more corners of the item containers. Alternatively, the passive mechanism may comprise a flexible “lip” with edges/corners that the item containers or bags are stretched around or over. The active mechanism may comprise one or more passive mechanisms that are actuated by a frame being snapped on/off of the top of an automated guided vehicle. At the end of an order (i.e., when the items associated with a customer order are dispensed into the mini bags), the mini bags may fall in a bigger bag when the top is removed, either passively by the weight of the items pulling them down or by an actuation mechanism. In some cases, frames can be loaded with bags after being installed on an AGV or may come pre-installed. The item containers of the present disclosure may be configured to compartmentalize items in a desired order into the same shipping package (e.g., a shopping bag) in an automated fashion.

### Conveyor to Conveyor Transfers

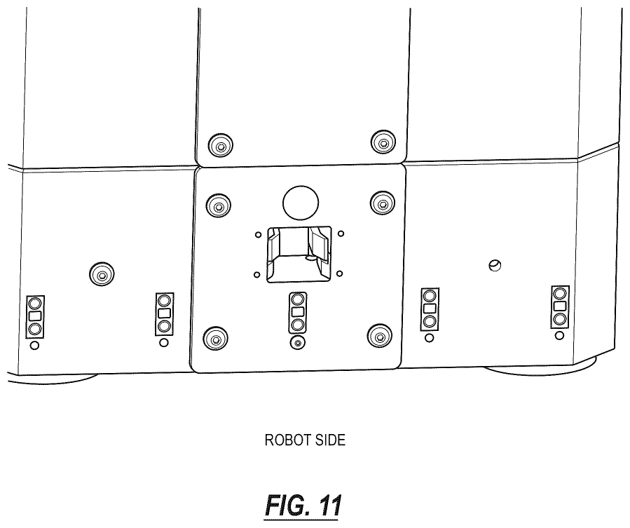

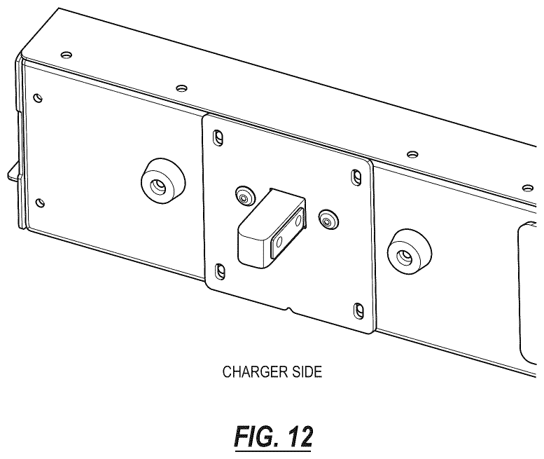

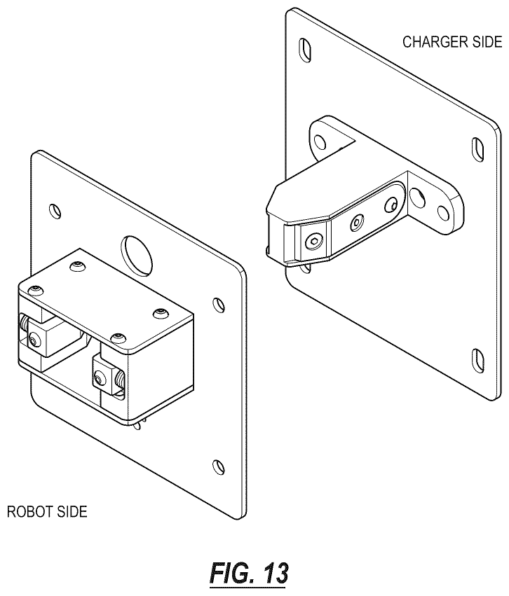

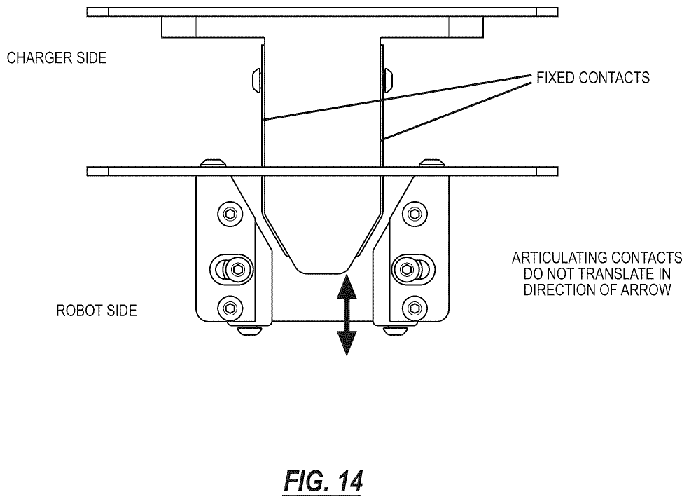

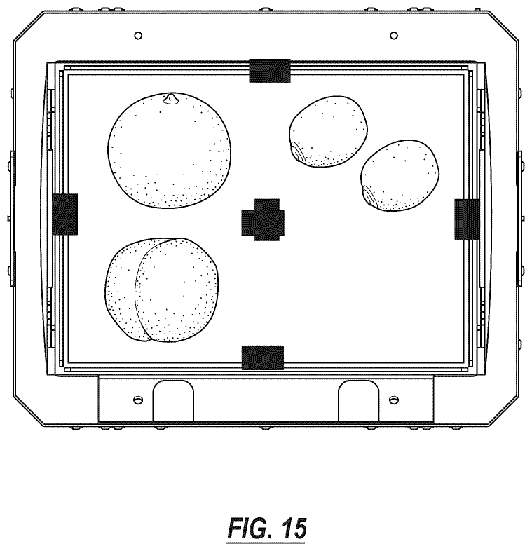

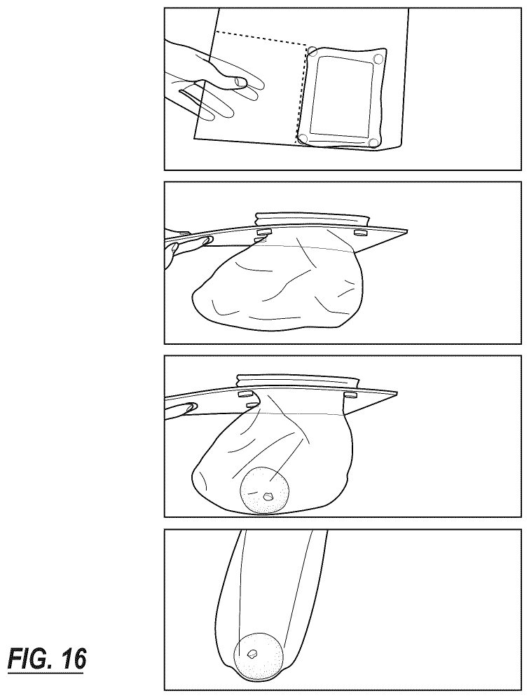

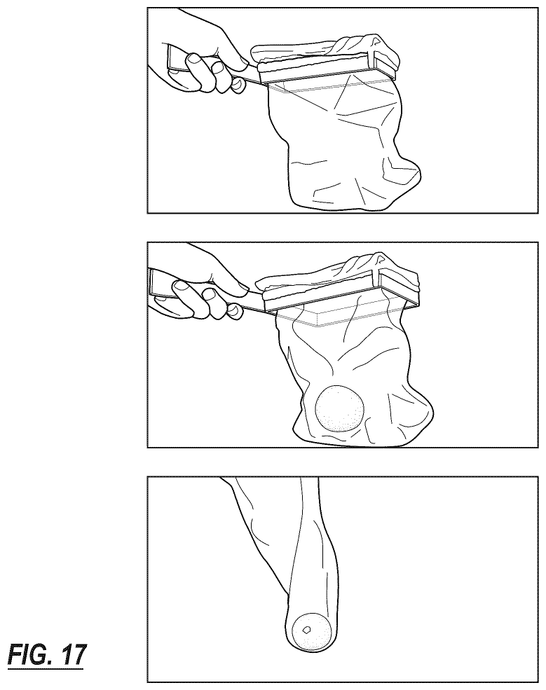

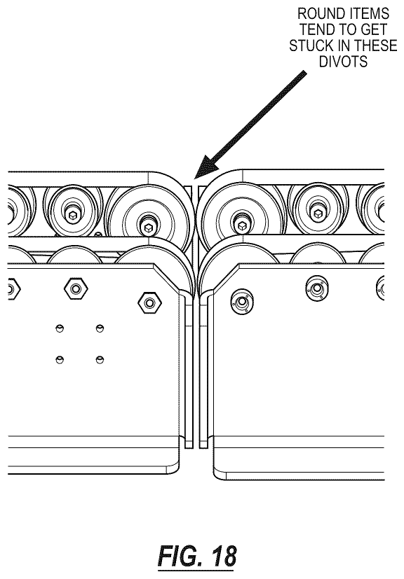

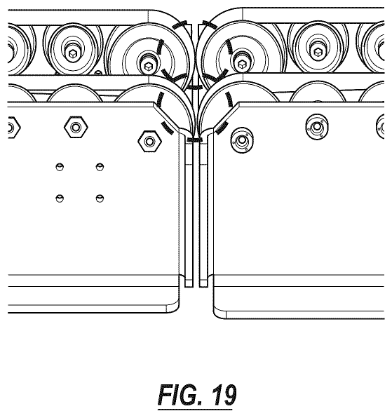

FIG. 18 and FIG. 19 schematically illustrate a divot between two conveyors positioned in series. In some cases, round items or items with circular cross sections may tend to get stuck in such divots while being transported across two or more conveyors positioned in series. The conveyors may comprise round belts driven by motors and turn around idler pulleys. The systems and methods of the present disclosure may be used in combination with one or more conveyor to conveyor transfer mechanisms to minimize a possibility of round items getting stuck in the divots between the conveyors, and to keep items moving smoothly through the conveyor transfers in a more controlled manner, thereby improving item throughput and Induction Success Rate (ISR).

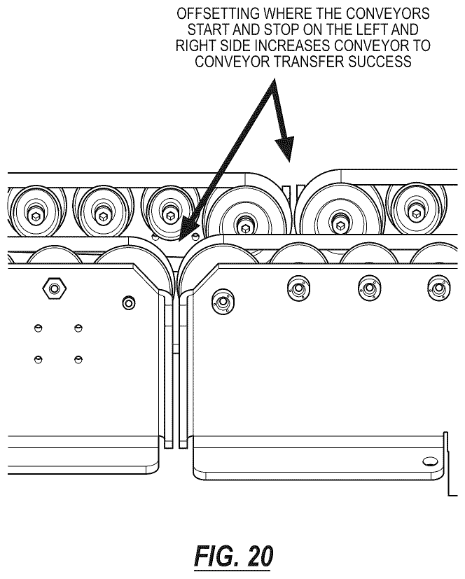

FIG. 20 schematically illustrates a conveyor to conveyor item transfer mechanism with offsetting where the left and right conveyors end and begin, to reduce the chances of items getting stuck in between divots between the conveyors. Offsetting where the conveyors start and stop on the left and right side increases conveyor to conveyor transfer success.

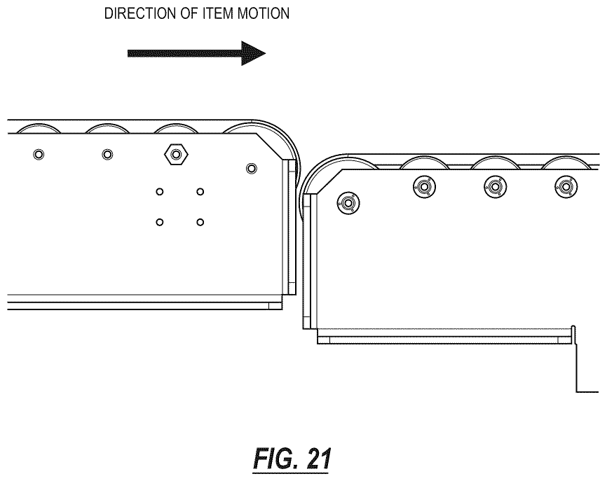

FIG. 21 schematically illustrates a conveyor to conveyor item transfer mechanism that implements a height difference between conveyors, similar to a waterfall configuration, to increase conveyor to conveyor transfer success.

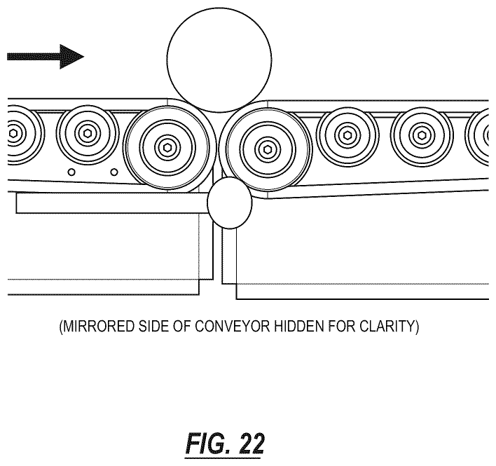

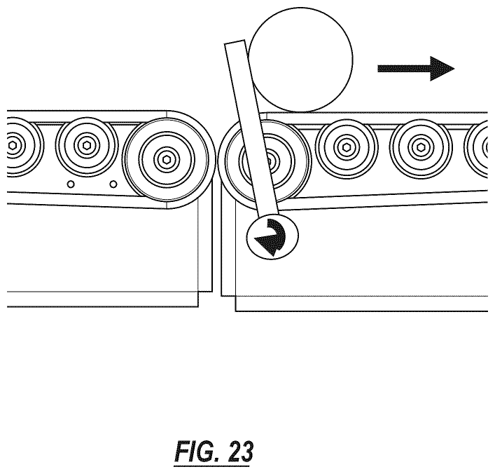

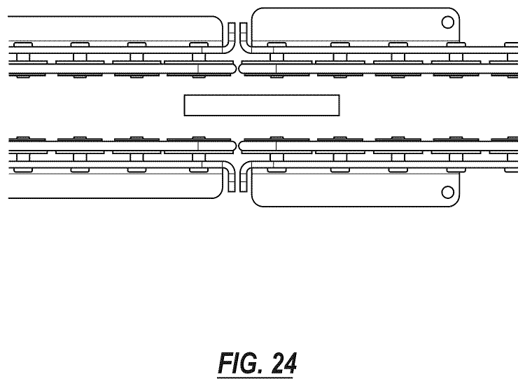

FIG. 22, FIG. 23, and FIG. 24 schematically illustrate another example of a mechanism for conveyor to conveyor item transfer, in accordance with some embodiments. The mechanism may prevent items from being stuck in divots between the conveyors. The mechanism may comprise a rotatable plate or lever that pushes items along the direction of motion so that items do not remain stuck in the divots between conveyors. The mechanism may be positioned between parallel conveyors at or near a divot and may push an item from underneath to keep the item moving in the desired direction of motion.

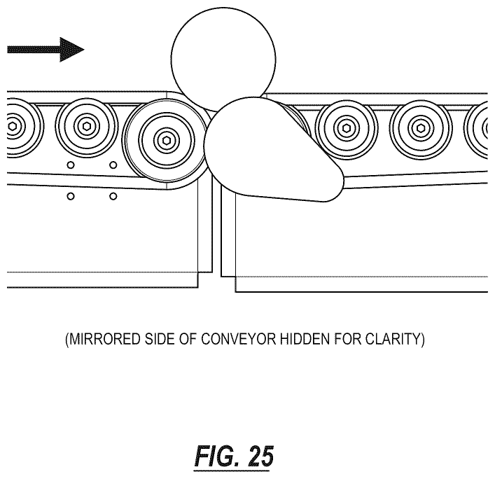

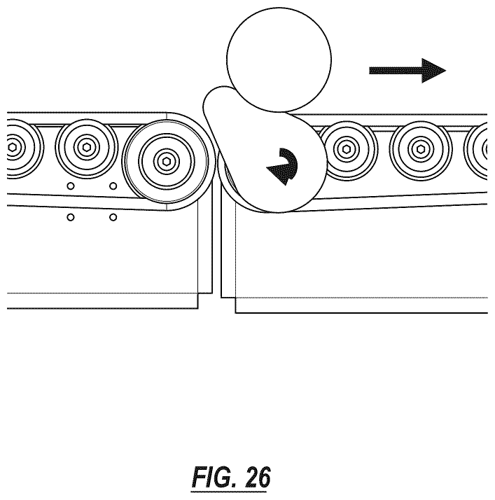

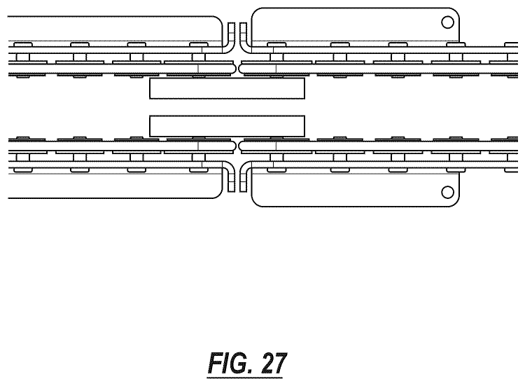

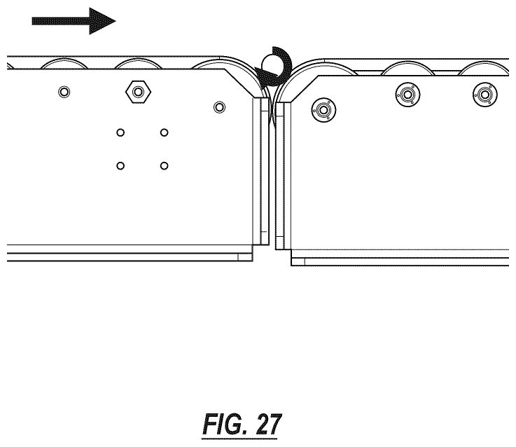

FIG. 25, FIG. 26, FIG. 27 schematically illustrates another example of a mechanism for conveyor to conveyor item transfer, in accordance with some embodiments. The mechanism may comprise a pivoting mechanism that is positioned between parallel conveyors at or near a divot. The pivoting mechanism may be configured to push an item from underneath to keep the item moving in the desired direction of motion, and to prevent items from being stuck in between the conveyors.

FIG. 28 schematically illustrates another mechanism for conveyor to conveyor item transfer, in accordance with some embodiments. The mechanism may comprise a cylindrical element or roller that is positioned at the divot and that fills the gap between the conveyors.

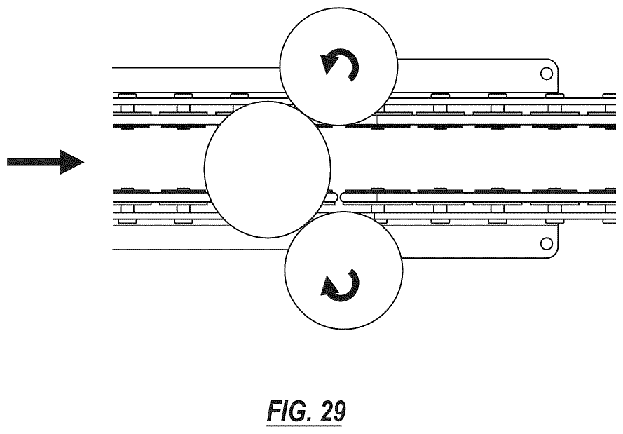

FIG. 29 and FIG. 30 schematically illustrates another mechanism for conveyor to conveyor item transfer, in accordance with some embodiments. The mechanism may comprise compliant brushes which rotate and help push items along the conveyors in a desired direction.

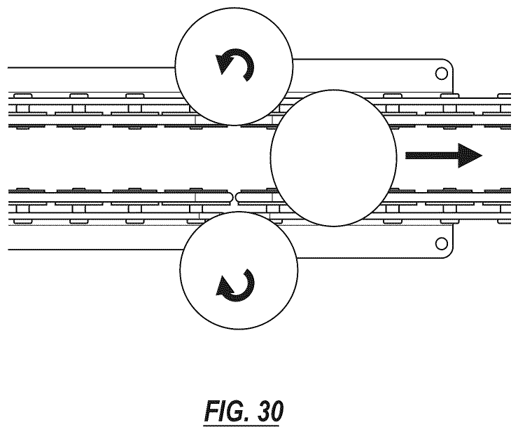

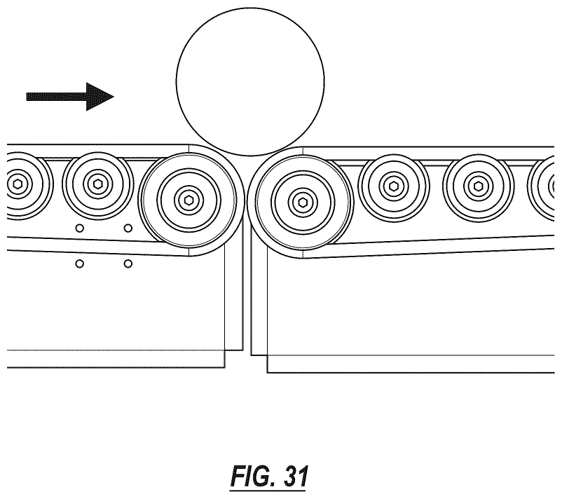

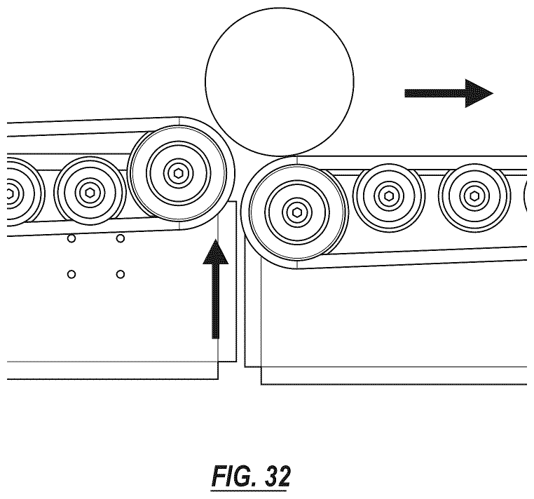

FIG. 31 and FIG. 32 schematically illustrates another mechanism for conveyor to conveyor item transfer, in accordance with some embodiments. The mechanism may comprise a mechanical element that is configured to move or raise an end roller of a conveyor up to clear items from the divot.

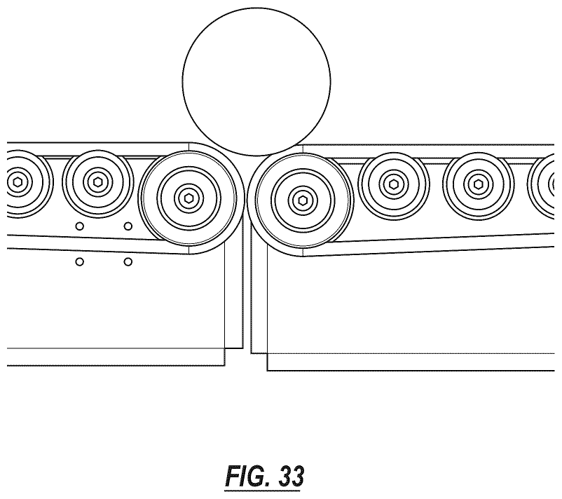

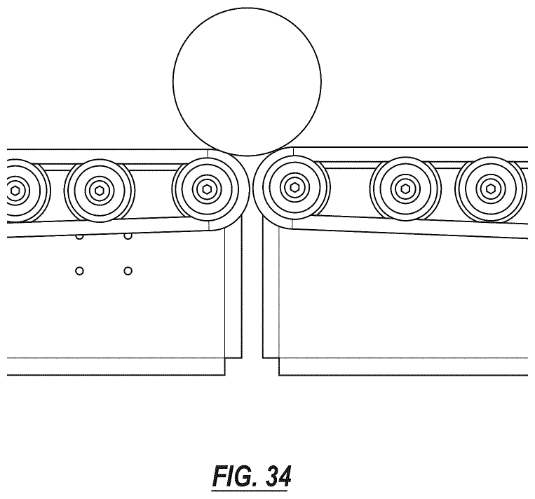

FIG. 33 and FIG. 34 schematically illustrates a conveyor to conveyor item transfer mechanism, in accordance with some embodiments. The conveyor to conveyor item transfer mechanism may comprise one or more end rollers that are smaller than the other rollers of the conveyors. Such smaller end rollers may reduce the divot size between conveyors and may be used in combination with other conveyor to conveyor transfer mechanisms to increase item transfer success rates.

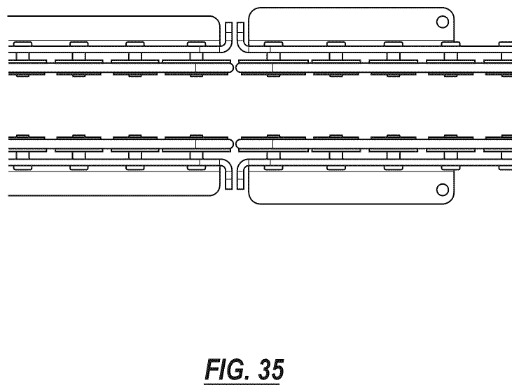

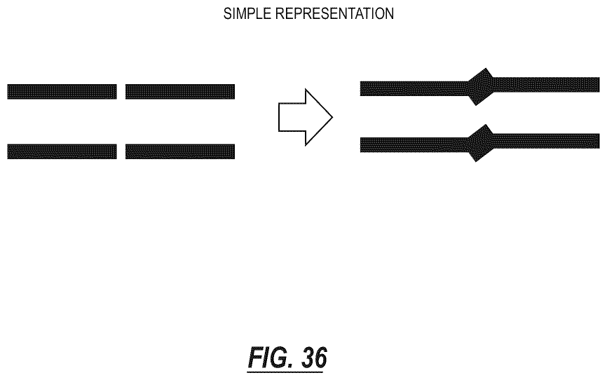

FIG. 35 illustrates a conventional conveyor to conveyor transfer interface for conveyors that are aligned in series with no overlapping portions. FIG. 36 schematically illustrates a mechanism for conveyor to conveyor item transfer with nested conveyors to eliminate the gaps in between conveyors.

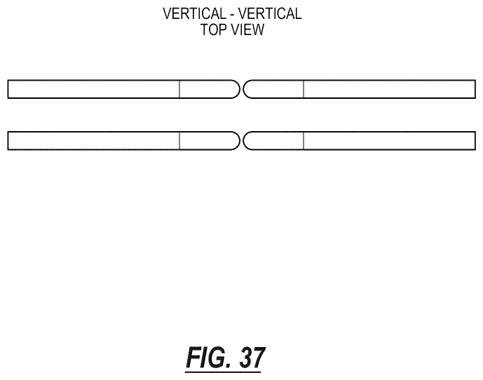

FIG. 37 schematically illustrates a top view of vertical-vertical conveyors for transporting items, in accordance with some embodiments. FIG. 38 schematically illustrates a side view of the vertical-vertical conveyors for transporting items shown in FIG. 37.

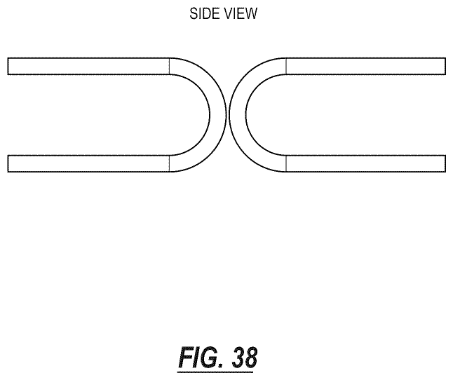

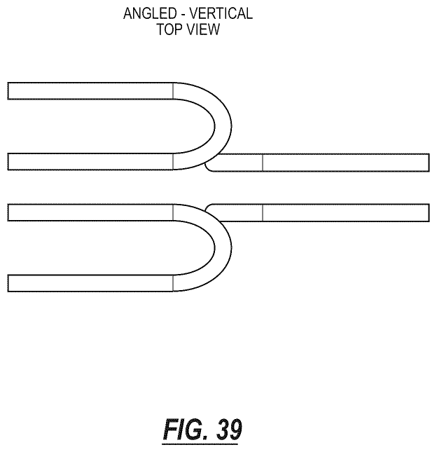

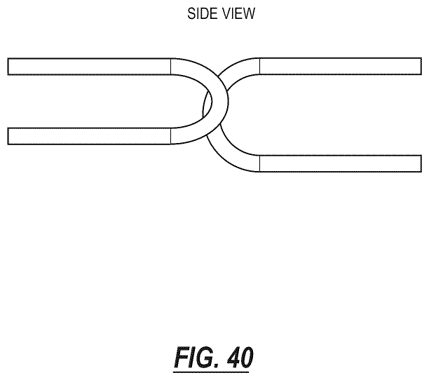

FIG. 39 schematically illustrates a top view of an angled conveyor adjacent to a vertical conveyor for conveyor to conveyor item transfers, in accordance with some embodiments. The angled conveyor may have one or more belts that are disposed at an angle relative to an axis corresponding to a direction of motion of the item along the conveyor. FIG. 40 schematically illustrates a side view of an angled conveyor adjacent to a vertical conveyor for conveyor to conveyor item transfer. The angled belt to vertical belt interface may be configured to reduce the divot size and may result in smoother item transfers and higher transfer success rates.

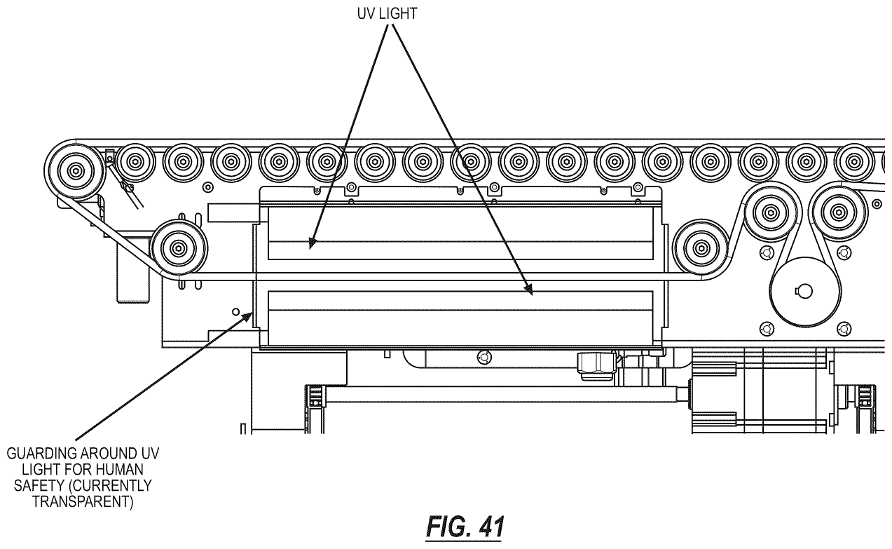

FIG. 41 schematically illustrates a system for sanitizing conveyor belts, in accordance with some embodiments. UV light is effective in killing bacteria. By running conveyor belts past UV light, the system can sanitize the belts at any desired time or frequency. The UV light may be positioned above and/or below the conveyor belt so that the belt can be sanitized more thoroughly. In some instances, the system may comprise guarding around the UV light source for human safety.

### Metal Tray Design with Customized Lane Spacing

The systems and methods of the present disclosure may be implemented using one or more trays. The trays may comprise a plurality of lanes on which one or more items may be placed or stored. The trays may comprise a plurality of openings through which a dispensing arm may be projected upwards to contact the one or more items provided or placed on the plurality of lanes. The trays may be wide enough to store a plurality of items and may be strong enough to support large loads. The trays may be manufactured using a metal (e.g., steel or aluminum). Wide trays may be used to leverage the cost of automation equipment used to manufacture the trays and may be used to store more items per dollar of capital cost. In some embodiments, the trays may comprise plastic or another suitable polymeric material. The trays may be designed to reduce development and manufacturing times. The trays may be designed to increase pop through tolerances or durability. Manufacturing the trays with a stronger material means the beams of the tray can be narrower, which can increase and improve pop through tolerances or durability.

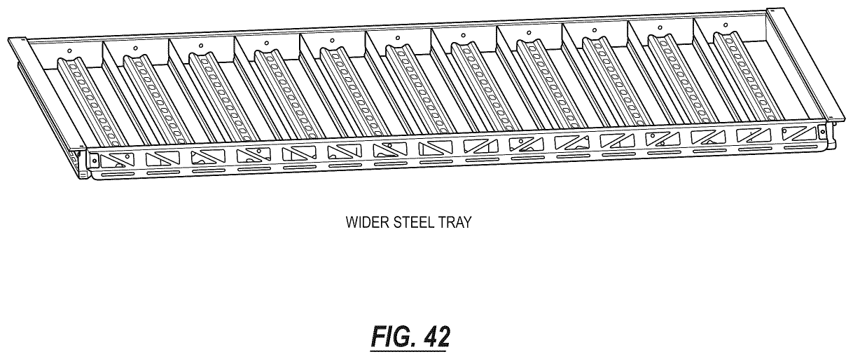

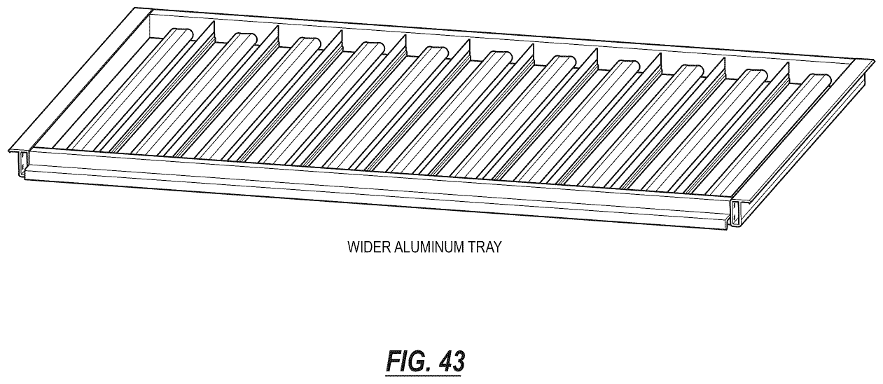

FIG. 42 and FIG. 43 schematically illustrate a tray design with customizable lane spacing, in accordance with some embodiments. The trays may be manufactured using a variety of materials. For examples, the trays may be made of one or more metals, such as steel or aluminum sheet metal or extruded aluminum.

The trays may be manufactured using a base modular design that enables the construction of many different types of trays with different dimensions or lane spacings. Once manufactured, the trays can be configured or reconfigured for customized lane spacing. In some cases, the trays can be manufactured using a single part with slots. Such trays can be manufactured using a large injection molded part or a large stamped sheet metal part or a large aluminum casting. Having one modular design for manufacturing can eliminate the need for separate sets of tooling to manufacture trays with different dimensions or lane spacings. In other cases, the trays can be manufactured using discrete parts that can be assembled together to create different trays with different dimensions or lane spacings. In such cases, some parts can be re-used in every tray version, or some parts may be re-used but with different counts. This can result in tooling that is much smaller and easier to manufacture and can reduce lead times and development times.

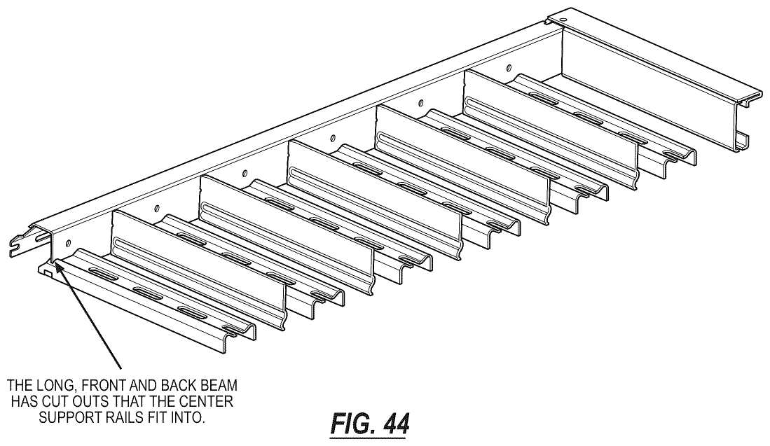

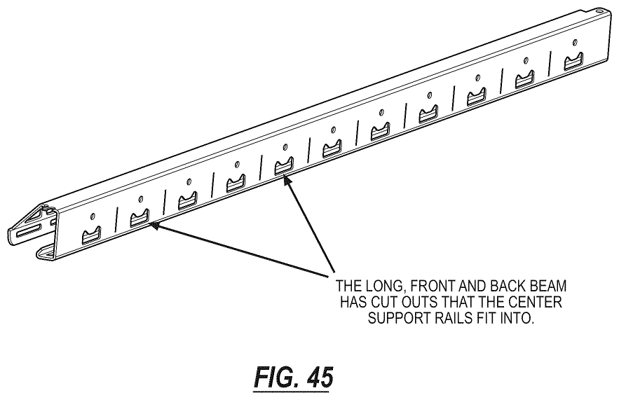

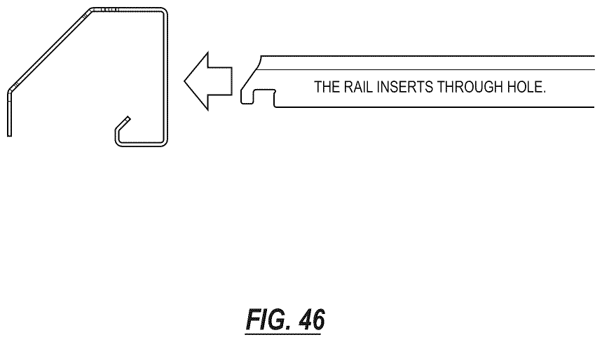

FIG. 44, FIG. 45, and FIG. 46 schematically illustrate a metal tray design that is configured for customizable lane spacings, in accordance with some embodiments. The long, front, and back beams of the tray can have cut outs that a center support rails can fit into. The support rail may be inserted through the holes or cutouts in the beams of the tray. For the trays manufactured based on a sheet metal design, the front beam may be different for every tray type. The profile may stay the same, but the hole patterns in the beams of the tray may change. All other parts or components of the trays may remain the same. For the trays manufactured based on an aluminum design, the front beam of the trays may be the same for every tray type, but the sheet with holes may vary. All other parts may remain the same, but the positions and/or the number of the cutouts used may be different depending on the type of tray needed or desired.

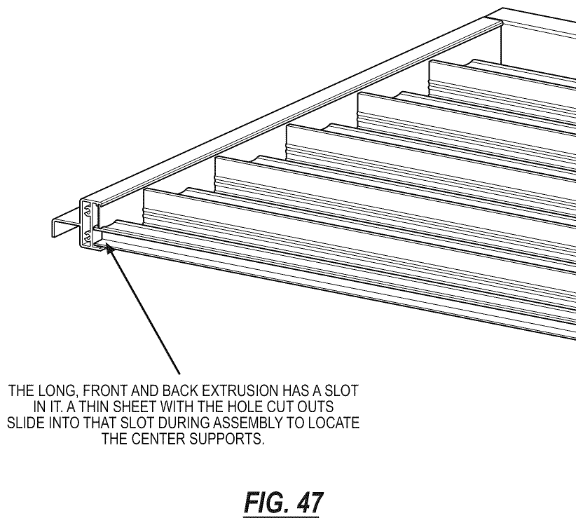

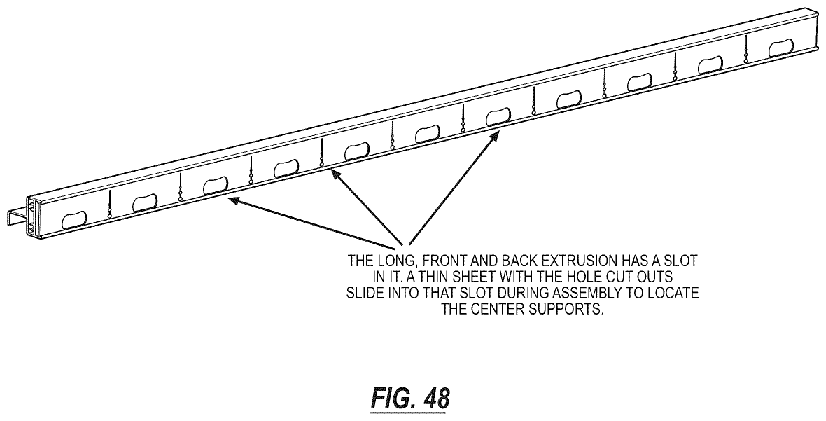

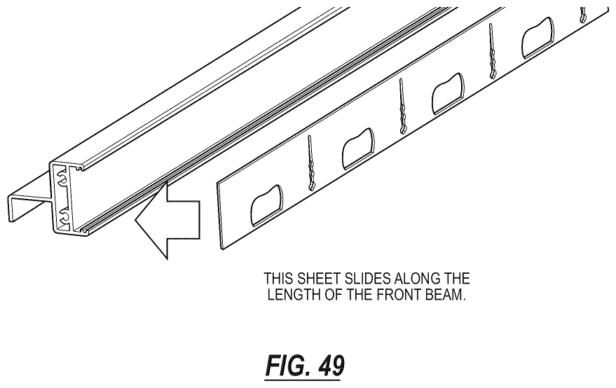

FIG. 47, FIG. 48, and FIG. 49 schematically illustrates a metal tray design with customized lane spacing, in accordance with some embodiments. The long, front and back extrusions of the tray may have a slot. A thin sheet with the hole cutouts can slide into the slot during assembly to engage with the center supports. The thin sheet can slide along the length of the front beam.

### Variable Tray Lane Widths

In some cases, it may make sense to have one lane width per tray. But it is also possible to have a plurality of lanes with variable widths. The metal tray designs disclosed herein may make this possible because it is easy to change center support positions and counts. Thus, any tray configuration can be made.

Trays with customized lane spacings and/or variable tray lane widths can accommodate many types of produce having variable sizes. A tray can be designed to have a lane size that works for all of the sizes of a typical item or box containing an item. Bell peppers, for example, might be between 60 mm and 125 mm in diameter. In a single box, there may be some variation in sizes. With varying lane widths, every bell pepper can fit on the same tray. Otherwise, multiple trays would be needed to accommodate that box.

It is also beneficial to have variable lane sizes that enable products to be grouped together that are frequently sold together. An algorithm can be used to identify sales volumes, frequency of items being ordered together, and the width of the items. Such an algorithm may be used to determine that a series of trays can be made with each width needed to accommodate various items or combinations of items. For example, spaghetti is a common dinner. When someone wants to make this for dinner, they may order a can of crushed tomatoes, a can of tomato paste, and a box of linguini. Each item may have a different width. Since such items are commonly purchased together, they can be grouped in one tray. Then, when it is time to dispense an order that calls for these items, only one tray needs to be fetched to get all three items. This will speed up the dispensing process. There may be very rarely used tray widths. Instead of having whole trays with a rarely used width, the tray designs disclosed herein can be used to combine two or three rare widths to ensure coverage for commonly purchased items with known dimensions, and to eliminate any wasted space.

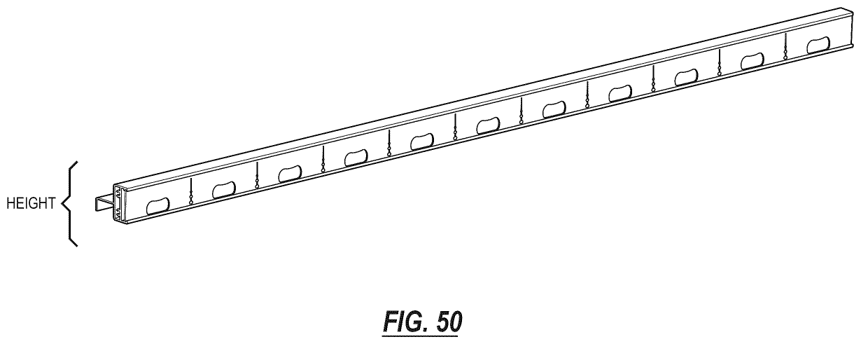

FIG. 50 schematically illustrates a tray component for variable tray support heights. The tray designs disclosed herein may be used to change the height of the tray itself. Most items can fit in a standard tray that is built for heavy objects. The trays of the present disclosure may be adjusted for a shorter height to store relatively thin items like candy bars and beef jerky pouches. This can increase item storage density, since two or more trays can now fit where one used to fit.

### Trays with Built-in Phase Change Material

FIG. 51 schematically illustrates a tray with cavities to receive a built-in phase change material, in accordance with some embodiments. Phase change materials (PCMs) change phase from solid to liquid at specifically engineered temperatures. This phase change can absorb large amounts of heat energy while maintaining a precise temperature, thereby allowing these phase change materials to act as “thermal batteries.” Designing trays with PCMs inside would allow for precise control over the temperature of items in the tray through direct thermal conduction or by cooling an enclosed air space by means of convection, without any external energy source. The trays would maintain a desired or required temperature until all PCM changes phase. When the tray is placed back into a thermally controlled environment, the PCM will “re-charge” by changing state back to a solid. PCMs built into the trays of the present disclosure would allow for precise food safety and quality-critical temperature control in the absence of externally temperature-controlled environments. A storage system comprising a plurality of PCM trays can also have its refrigeration system turned off for long periods of time while still maintaining the target temperature. PCMs may be incorporated into the tray designs of the present disclosure in many ways. The extruded aluminum tray design may have many hollow cavities that could easily be filled with a PCM and capped at the ends.

### Multiple Depth Tray Storage

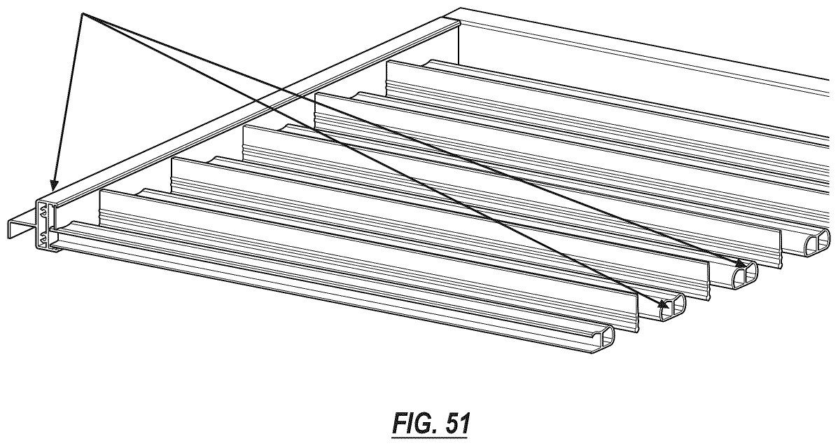

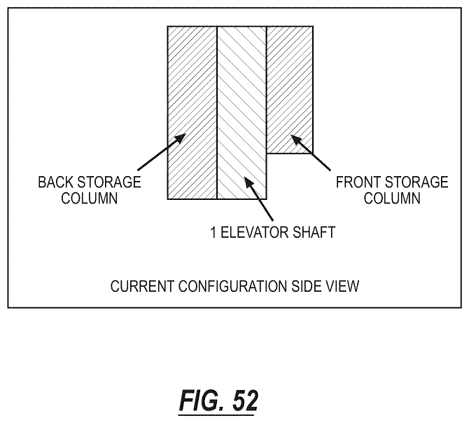

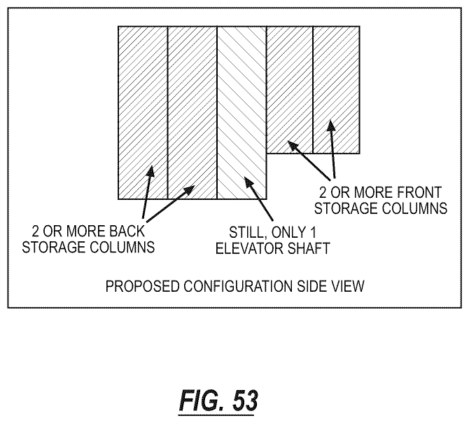

FIG. 52 and FIG. 53 schematically illustrate a multiple depth tray storage unit, in accordance with some embodiments. In a storage system where trays are stored in a front storage column and a back storage column, a column of stored trays is always adjacent to an Elevator Shaft for quick access. In an alternative embodiment, the storage system may comprise multiple columns of storage columns per elevator shaft. The multiple columns can comprise two or more front storage columns and/or two or more back storage columns. This can increase storage per $ of capital cost. In such cases, the elevator used to access the trays would need a way to pick from each column.

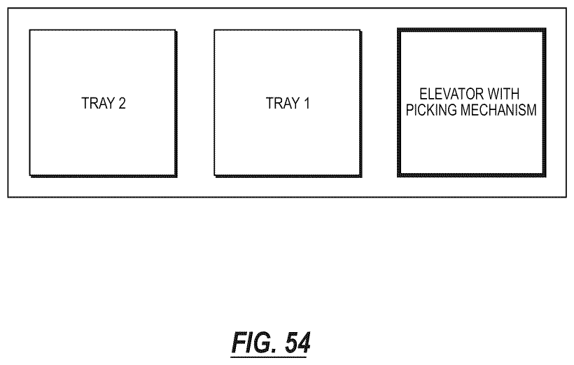

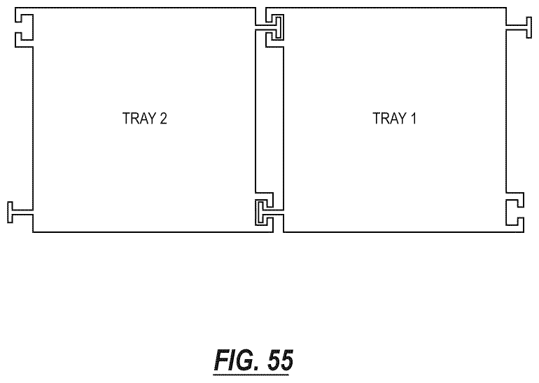

FIG. 54 and FIG. 55 schematically illustrate trays that are configured to couple together to enable an elevator to access the trays in tray storage columns that are not always adjacent to the elevator shaft. The trays may be linked together with a T slot feature. In such cases, the elevator may move into place to pick a desired tray. A picking mechanism may engage with tray 1 to pull it onto the elevator. Tray 2 may be already linked to Tray 1 with the T slot feature. Once Tray 2 is in Tray 1's initial resting spot, the elevator stops its pulling motion, moves vertically to disengage Tray 1 from Tray 2, and then proceeds to bring Tray 1 fully on board the elevator. Tray 2 may then be in a position to be directly picked by the elevator. In some cases, there may be 2 or more trays linked together using T slot features. Each tray would move together while in storage and can then unlink during the final pick. To replace a tray, the same procedure can happen in reverse order.

The T slot features may be parallel to the elevator shaft. When a first tray gets pulled, a second tray behind the first tray will move with the first tray. When one tray is moved vertically relative to another tray, it will disengage the link and enable the trays to move separately.

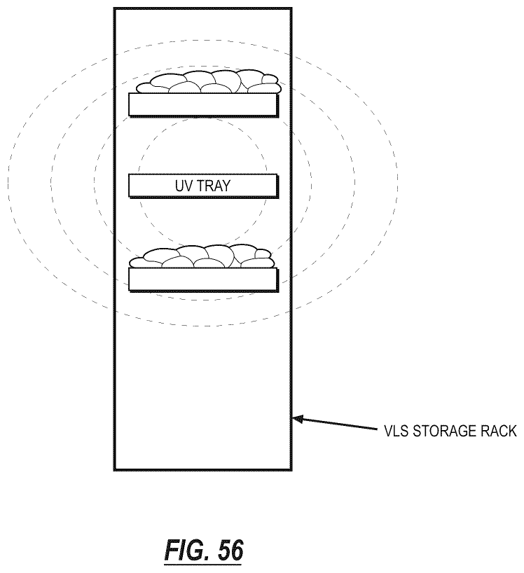

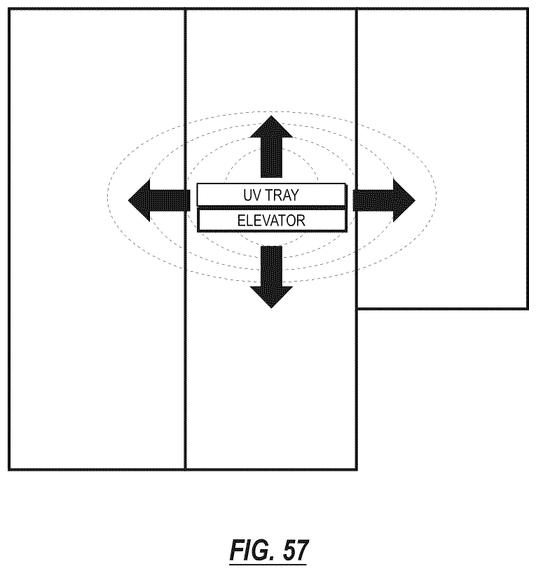

FIG. 56 and FIG. 57 schematically illustrate UV tray sanitization, in accordance with some embodiments. Items held in trays in storage can be irradiated from the top and/or bottom due to the slatted design of trays. The UV tray sanitization system may comprise a storage rack. The storage rack may comprise a vertical lift system (VLS). Sterilizing light can reach all parts of the interior of the tool by riding on the elevator and being placed on a storage shelf.

### Bag Transport/Bag Carrying AGV

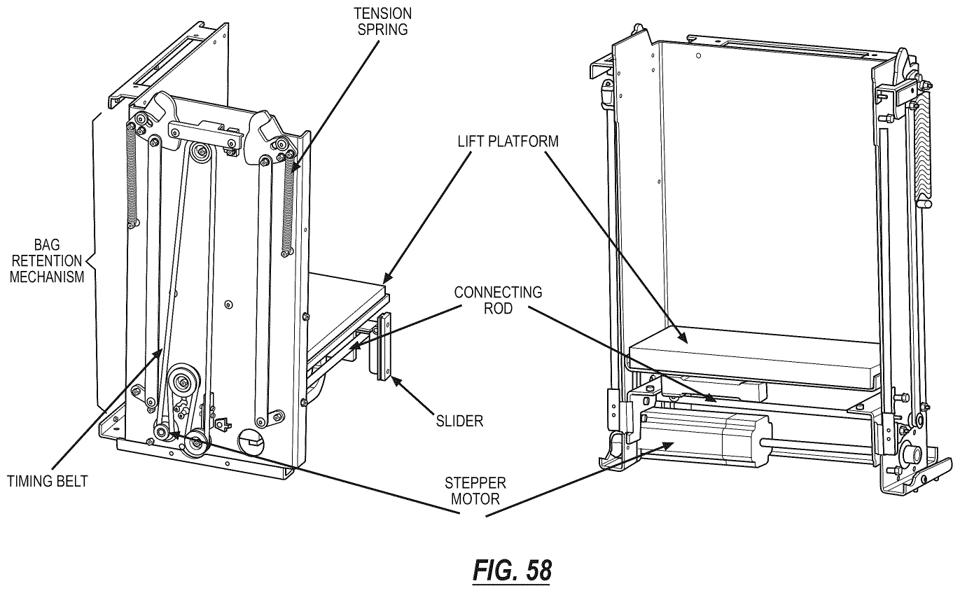

FIG. 58 schematically illustrates a bag carrying AGV, in accordance with some embodiments. The bag carrying AGV may comprise a belt and pulley shelf height control mechanism. A lift platform may be constrained within an enclosure of the bag carrying AGV so that it can only move vertically when connected at each end to a timing belt. This timing belt can be connected to a series of timing pulleys that are turned by a motor (e.g., a stepper motor). This motor can have an extended shaft to move the timing belt on either end of the platform simultaneously. The movement of the belt can raise and/or lower the lift platform.

The bag carrying AGV may comprise an integrated bag capture and shelf height control mechanism. As the lift platform lowers, it can contact a bar, rod, or tab that act as the pivot point for a set of linkages that actuates a bag retention mechanism. As the platform bottoms out, the bag may be released. When a new bag is inserted, the platform raises, and a tension spring raises the arms to retain the bag.

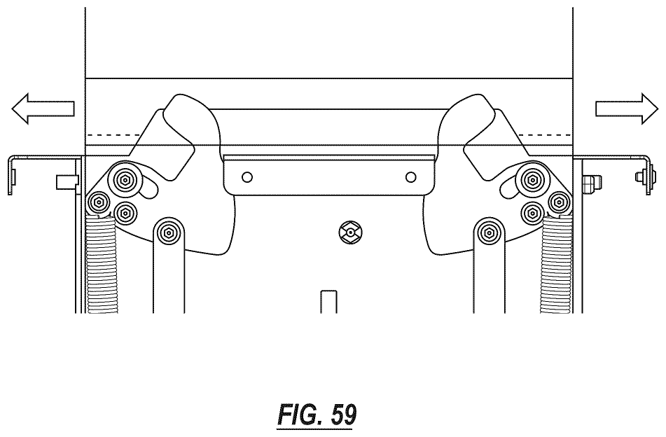

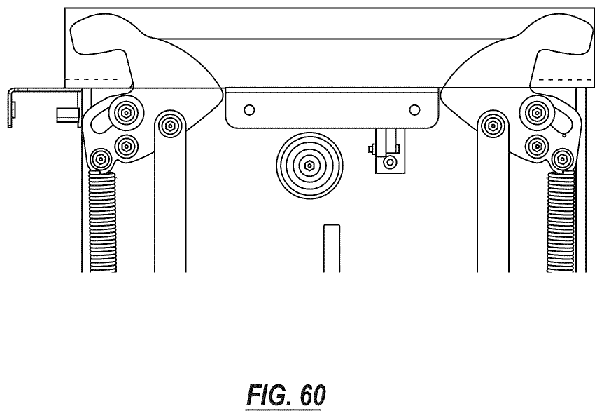

FIG. 59 and FIG. 60 schematically illustrate a bag capture mechanism, in accordance with some embodiments. The mechanism that is actuated by the lift platform has a set of hooks on one link. These hooks are designed to slide in and out of specially sewn pockets in the bag, one at each top corner of the bag. When in the down position, the hooks are positioned so that the bag can be easily inserted/removed. When the hooks are released, the spring force pushes the hooks into the pockets, creating a taught top bag structure.

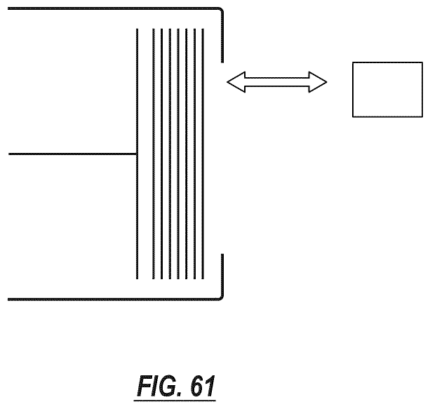

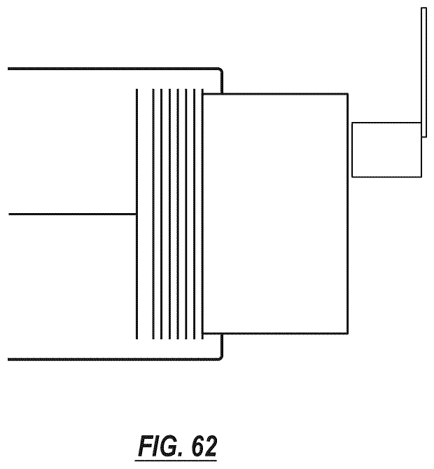

FIG. 61, FIG. 62, and FIG. 63 schematically illustrate a tool for automatically putting a bag into an item container in accordance with some embodiments. The bags may be stored in a flattened state in a spring-loaded magazine (1). A suction cup/grabber can be used to pull the bag open from the magazine (2). A plunger may come down from above the opened bag to push the bag into the bag cavity of the item container (3). The plunger can push the bottom of the bag to the adjustable platform of the AVG while a sliding skirt pushes the top of the bag onto the bag retention mechanism and the handles of the bag into their holding spots.

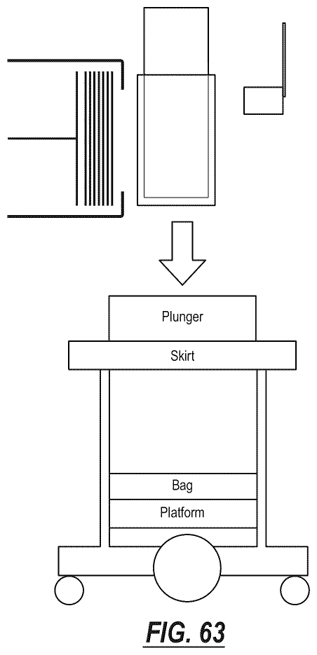

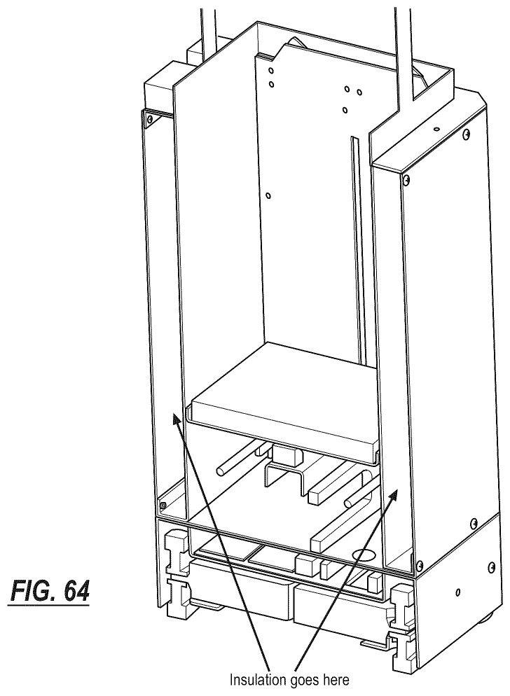

FIG. 64 schematically illustrates a thermally enclosed item container robot or automated guided vehicle AGV that carries trays, in accordance with some embodiments. Air gaps between a bag holding area and an exterior of AGV can be filled with insulating material or a combination of insulating material and cooling/heating element to actively maintain bag temperatures within a desired or predetermined range. Cooling can be achieved through a number of methods including a standard refrigeration system, a phase change material, or frozen containers or bottles of liquid.

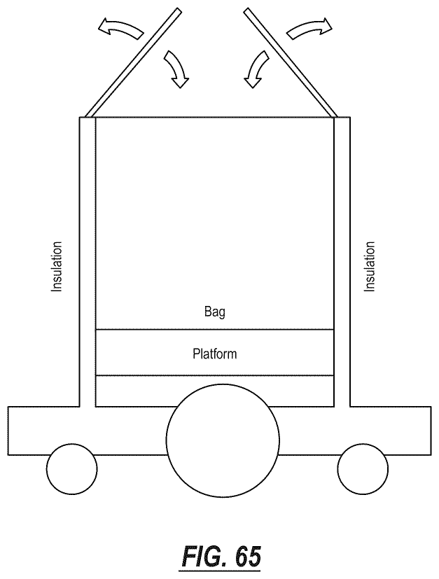

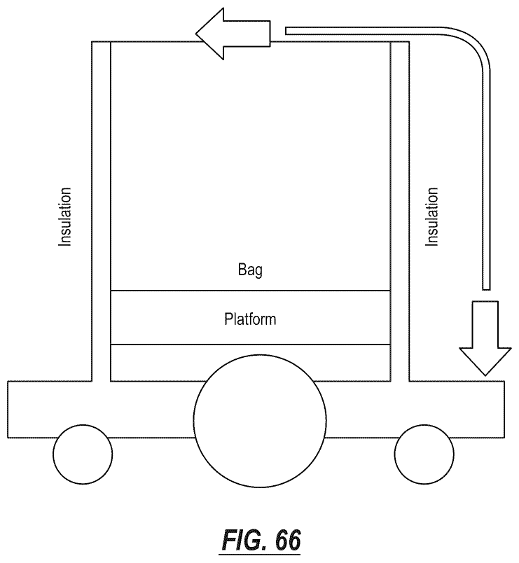

FIG. 65 and FIG. 66 schematically illustrate a top cover for a thermally enclosed item container, in accordance with some embodiments. The top cover may comprise single or multi part rigid covers with hinges that fold down from a top of the bag. The hinges may be coupled to an edge or a side of the bag. In some cases, the top cover may comprise a flexible single or multi part cover that slides over a top or a side of the bag. The top cover may minimize, reduce, or prevent convective heat transfer to items or contents within the bag. The top cover may be used in combination with insulation to reduce changes in temperature to the items or contents within the bag.

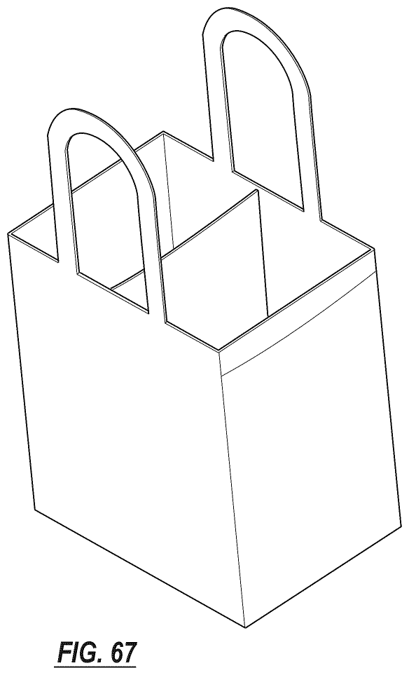

FIG. 67 schematically illustrates a multi compartment collapsible bag, in accordance with some embodiments. The multi compartment collapsible bag may be a reusable, collapsible bag that has multiple, separate compartments of various numbers for organizing items. There may be 2 or more compartments. The compartments can be sewn in fabric or may be formed using separate inserts made of plastic, cardboard, or some other rigid or non-rigid material.

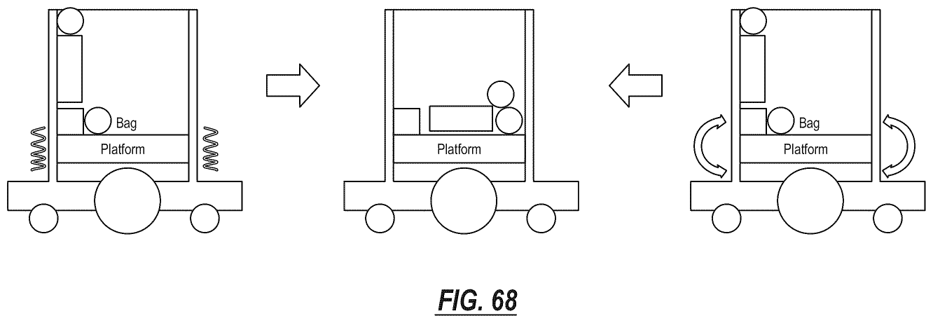

FIG. 68 schematically illustrates a method of reorganizing items in a bag, in accordance with some embodiments. The items or contents inside the bag may be shuffled through the use of vibration or tilting, to more efficiently organize contents that have already been dispensed into the bag.

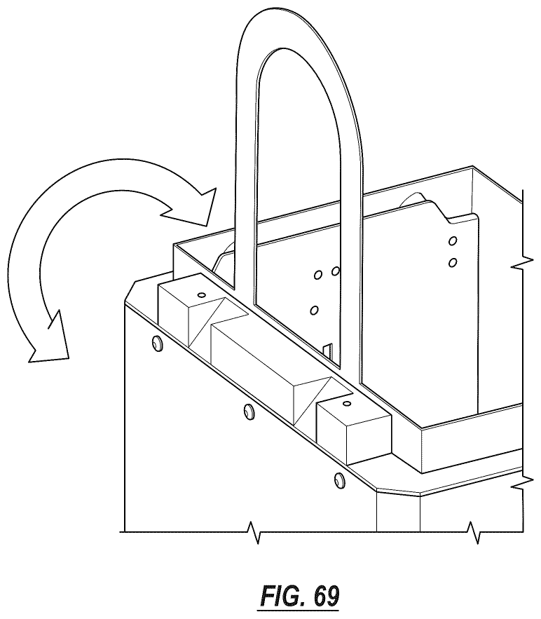

FIG. 69 schematically illustrates a bag handle retention and ejection mechanism, in accordance with some embodiments. The bags of the present disclosure may comprise one or more handles. The bag handles may be pressed into special retaining slots during an insertion process. The handles may be ejected from their holding slots by a mechanism powered either off a lift platform of the bag, a motor, or a solenoid in such a way that the handles are positioned or repositioned inside of the bag and on top of the contents, so that the handles can be easily grabbed with one hand.

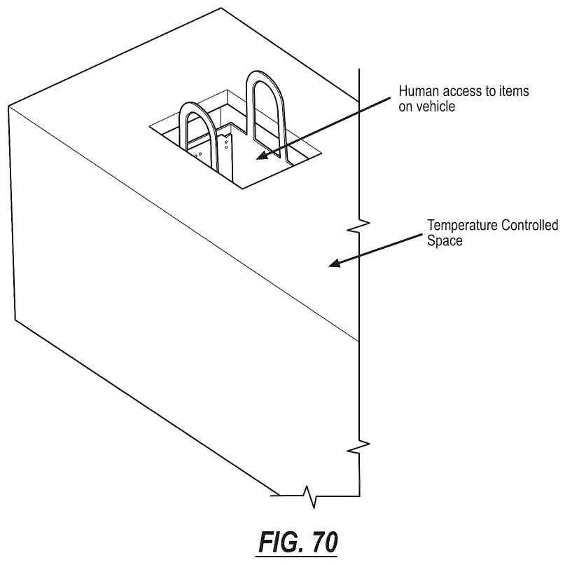

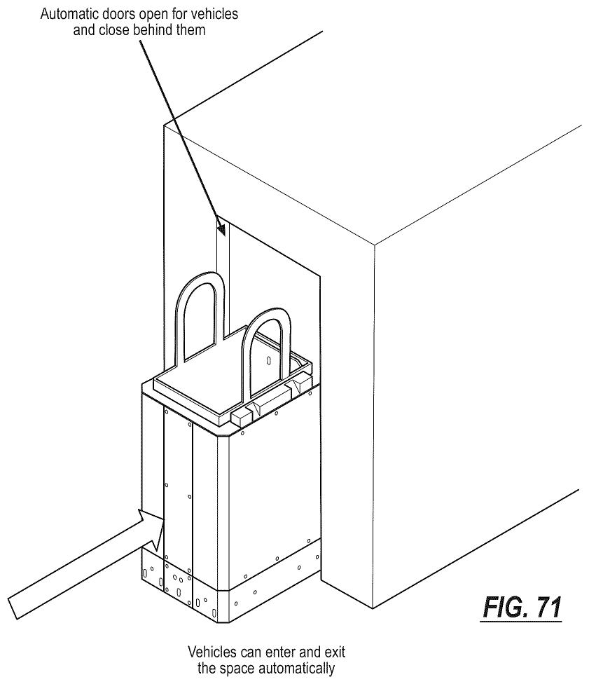

FIG. 70 and FIG. 71 schematically illustrate a temporary temperature-controlled storage of bags before pickup, in accordance with some embodiments. Completed orders may travel into an environmentally-controlled machine or space while waiting to be picked up by a consumer or a delivery entity. Entering and exiting the space can be automated with powered doors. The refrigerated space may be accessed by people, AGVs, and/or autonomous vehicles. The temperature-controlled machine or space may facilitate cold storage of bagged items and may enable interactions between people and the items carried on the bots without requiring people to enter the cold environment, similar to a reach in cooler. Alternatively, the temperature-controlled machine or space could also be more similar in size to a walk-in refrigerator and may enable access by humans, AGVs, and/or autonomous vehicles. Quickly fulfilled orders may have to wait a considerable amount of time before they are picked up. Keeping waiting orders in a temperature-controlled environment improves food safety and quality by slowing the thaw rate of frozen items and providing refrigeration benefits for fresh foods or produce. An enclosure sized and/or shaped specifically for autonomous vehicles would be small and efficient and may enclose the normal pathway of an AGV. Integrated human interaction points may permit retrieval of items from the autonomous vehicles, without the need for people to enter a cold environment. The structure could also shield people from the vehicles, creating a safe and aesthetically pleasant item retrieval portal.

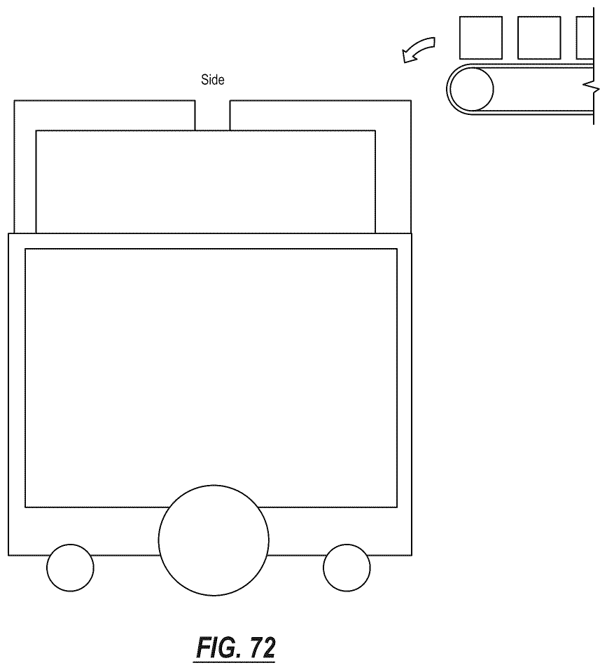

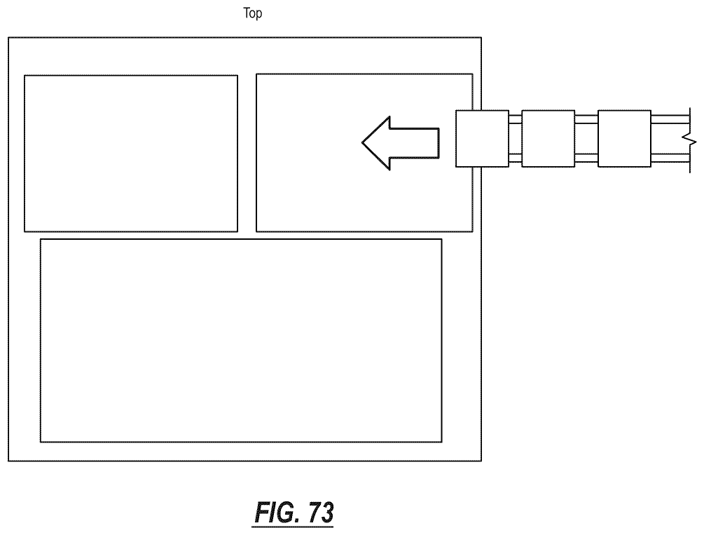

FIG. 72 and FIG. 73 schematically illustrate an AGV that holds multiple boxes at the same time, in accordance with some embodiments. The AGV may be configured to receive dispensed items and to transport the dispensed items for delivery (e.g., to a customer's vehicle or a delivery vehicle—manned or unmanned). Instead of a single, central bag that holds one or more items, the AGV may have a platform on top that can hold multiple larger boxes that may be filled with smaller items in order to fulfill multiple orders with a single AGV. An AGV may be configured to hold one or more boxes on a top surface, portion, or platform of the AGV. In some cases, the AGV may be configured to adjust its position and/or orientation relative to one or more conveyors dispensing the items so that the items are dispensed into different boxes as desired.

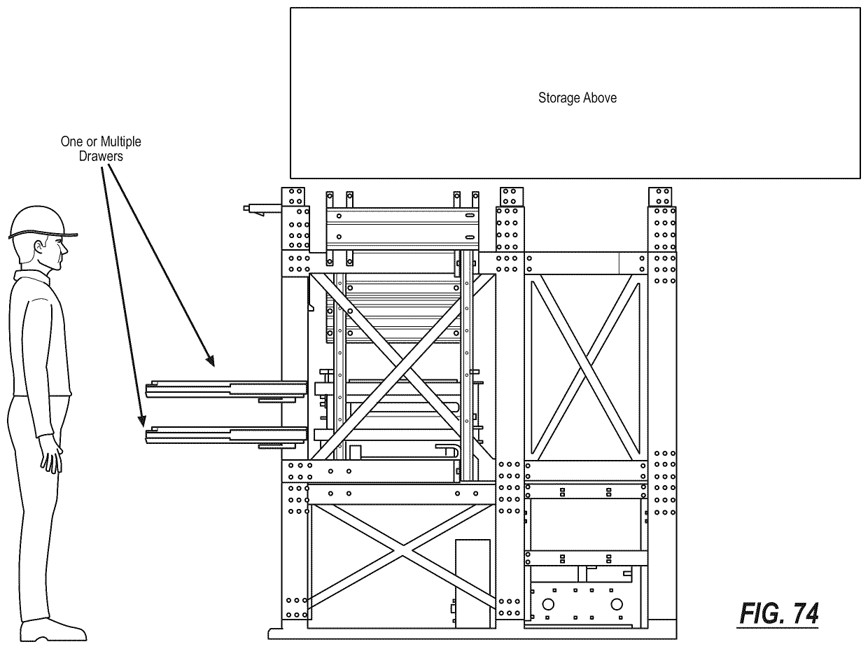

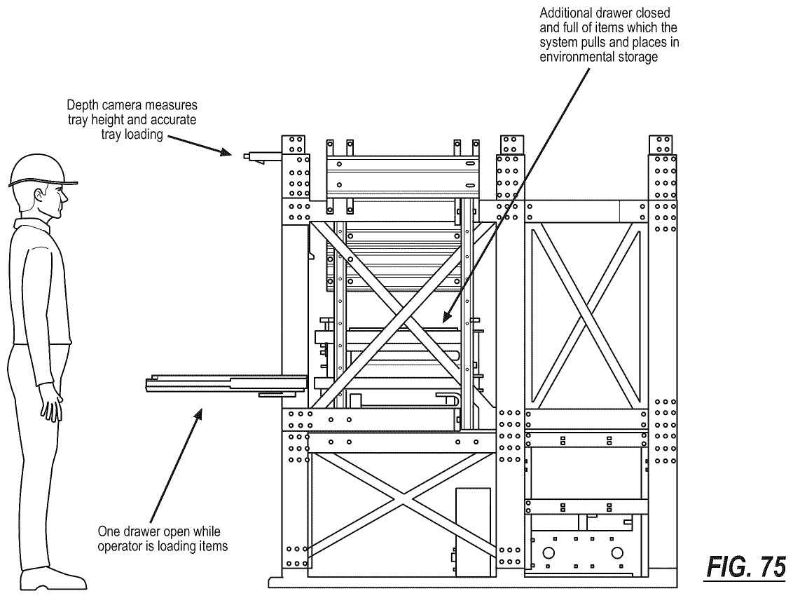

FIG. 74 and FIG. 75 schematically illustrate a mechanism for manually loading items into inventory to interface with an automated storage system, in accordance with some embodiments. The mechanism may comprise a drawer system which an operator opens to load items into inventory. The drawers may be deployed outwards towards an operator and may lock open and/or closed to only permit the operator to open/close the drawers when the system allows. In some cases, one drawer may remain open while the operator is loading items. In some cases, the drawers may comprise a user interface and a light box to guide an operator to properly store the items in the correct location and orientation on the drawers. The drawer system may further comprise a depth camera that measures a tray height and monitors accurate tray loading. A standard RGB camera may also be used, either alone or in combination with the depth camera. Pictures of the trays may be used to monitor performance of the system. The captured images may be segmented into smaller pictures. The pictures may be shared with customers over a network, for example through a web interface or a mobile application. Additional drawers of the drawer system may be loaded with items and closed, and may be pulled into the drawer system and placed in environmental storage to control a temperature, humidity, etc. of the items placed in or on the drawers.

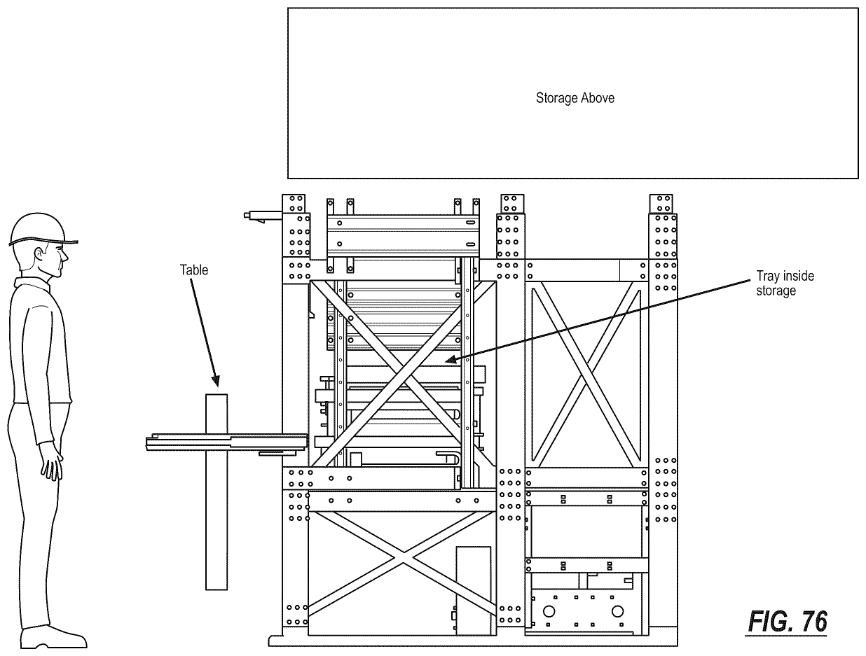

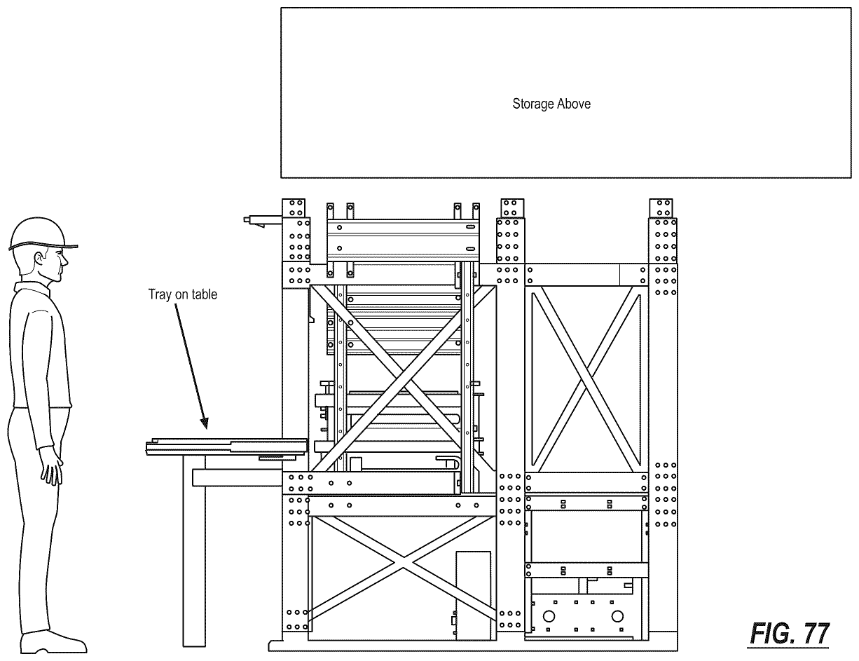

FIG. 76 and FIG. 77 schematically illustrate a mechanism for manually loading items into inventory to interface with an automated storage system, in accordance with some embodiments. The mechanism may comprise a table system where the operator pulls a tray onto a table to load one or more items. In some cases, the table may comprise a user interface or light box to guide an operator to properly store the items in the correct location and orientation.

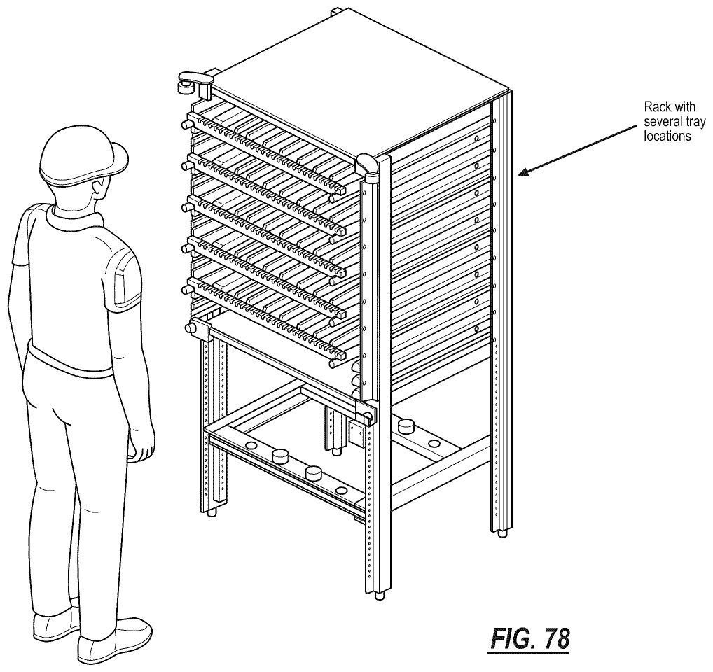

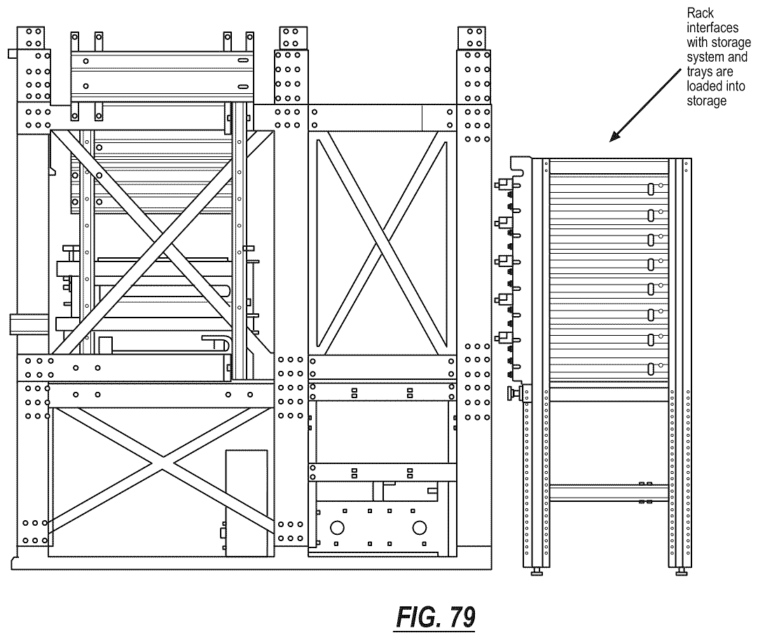

FIG. 78 and FIG. 79 schematically illustrate a mechanism for manually loading items into inventory to interface with an automated storage system, in accordance with some embodiments. The mechanism may comprise a rack system with several item carriers (e.g., trays). The rack system may be configured to receive a plurality of trays and to position the trays at different heights within the rack system. An operator may directly load items into the trays of the rack system. In some cases, the rack system may comprise a user interface or light system to guide the operator to place the items into the correct locations and correct orientation. The rack system may interface with a storage system and may be taken directly to an environmentally controlled storage system. In such cases, the trays may be loaded into the environmentally controlled storage system.

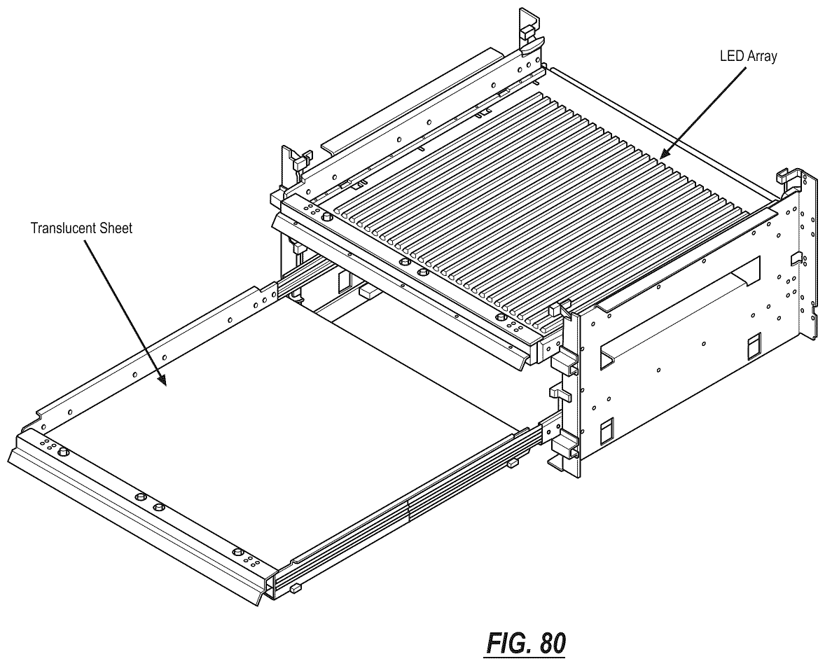

FIG. 80 schematically illustrates a lightbox below a tray to aid in tray filling, in accordance with some embodiments. The lightbox may comprise an array of light emitting diodes (LEDs). LEDs underneath the tray may light up to provide the operator a visual indication on where to place the items in the tray. The visual indication may be a spot marker or may provide an outline of the size and/or shape of the items to be placed in the tray. The LED array can either light up the whole lane or it can light up specific spots in a tray. The LED array can have a translucent cover for easy cleaning while still allowing the lights to shine through.

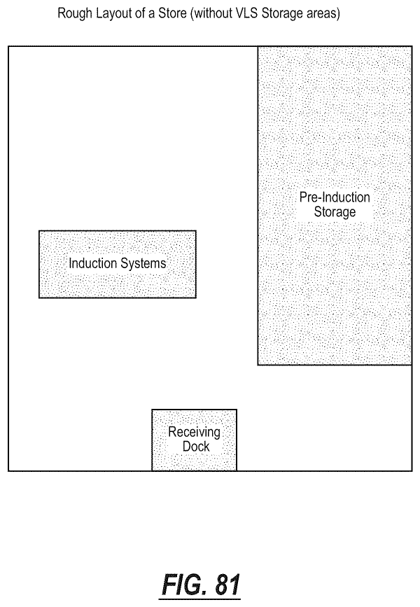

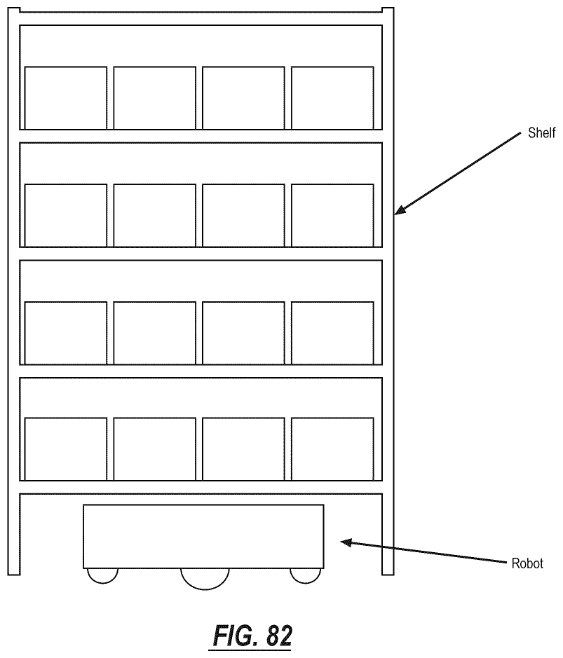

FIG. 81 and FIG. 82 schematically illustrate a pre-induction storage system, in accordance with some embodiments. Goods may be received at a receiving dock and may be stored or held in pre-induction storage before being transported to an induction system of a product handling and packaging system. One or more AGVs may be configured to transport, organize, and temporarily store goods between receiving and induction. In cases where there are no AGVs configured to coordinate pre-induction storage, goods may be received at a dock, pallet jacked over to the pre-induction storage, and placed on several shelves within the pre-induction storage. A human operator may then take a shelf containing the items over to the induction system, load the items into the induction system, and then may walk the empty shelf back to pre-induction storage to place the empty shelf back in the pre-induction storage. The human operator may then pick a new shelf from within the pre-induction storage to move back to the induction system. One or more AGVs may be used to automate and/or streamline this process. For example, in cases where one or more AGVs are used, goods may be received at the dock, and the goods may be placed on several robotic shelves. The robotic shelves may be configured to transport the goods to the pre-induction storage system and may further transport the goods from the pre-induction storage to the induction system of the product handling and packaging system. As such, when a human operator walks over to the induction system, the robotic shelf will be waiting at the induction system for the human operator to load the goods in the robotic shelf into induction system. Once the human operator loads the goods or items into the induction system, another robotic shelf may be configured to arrive at the induction system to enable the human operator to continue loading goods or items into induction system while the empty shelf puts itself away. Even if a store is designed in an optimal way to reduce walking trips by an operator, having the storage shelves be robotically moving can reduce the workforce needed to run the store. The shelf and robot may be separate entities so that there can be many cheap shelves for storage and few expensive robots to move them around the store. In some cases, the robots can pick up the shelves off of the floor and move them to the pre-induction storage and/or the induction system.

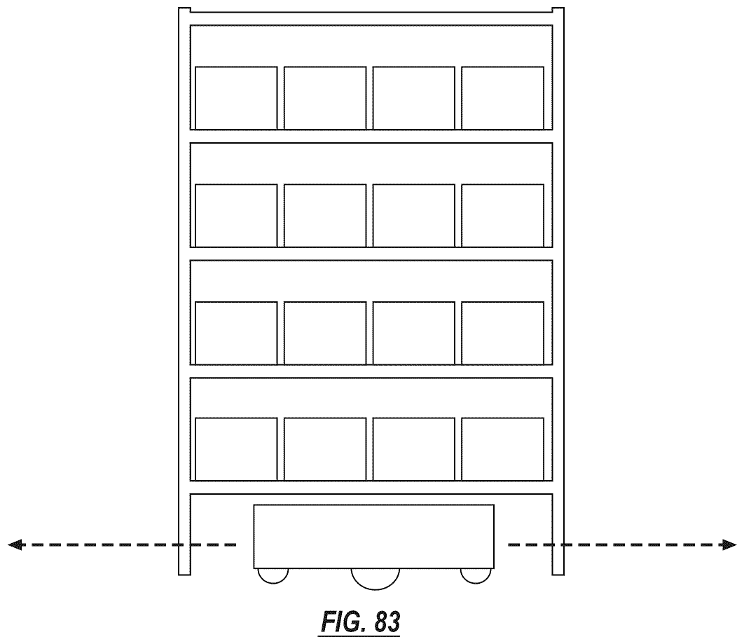

FIG. 83 schematically illustrates a pre-induction storage system without thermal isolation. In cases where a pre-induction storage system does not use thermal isolation, goods that need to be refrigerated or frozen need to be moved in small amounts to the induction system so that their time outside of proper environmental storage is reduced (thereby maintaining the cold chain).

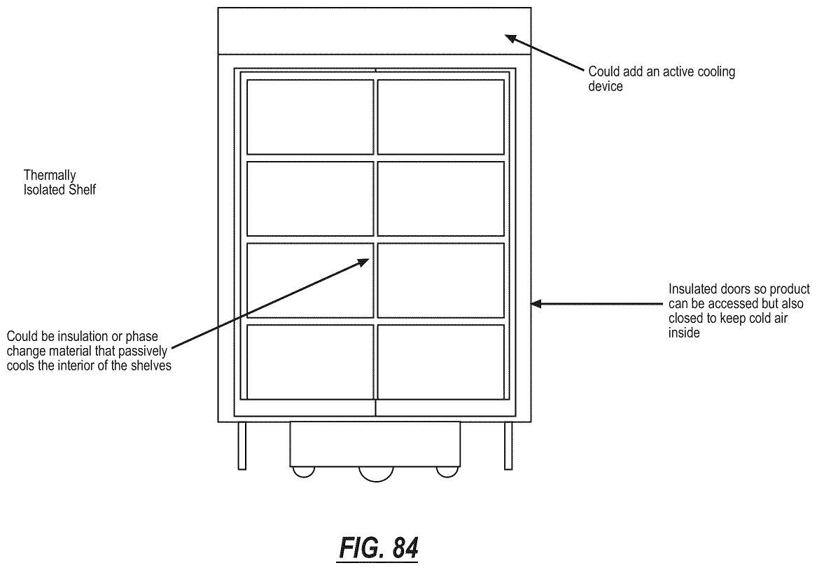

FIG. 84 schematically illustrates a pre-induction storage system with thermal isolation. The pre-induction storage system may comprise thermally isolated shelving that can help keep the cold chain throughout the induction process. In cases where the pre-induction storage system utilizes thermally isolated shelving, many goods can be brought out of their walk-in refrigerator or freezer if the shelving unit is thermally isolated or even actively cooled to keep the items in the proper environmental storage. By allowing more items to come out of pre-induction storage, less shelves, robots, and trips are required to transport the items to the induction system, and overall induction efficiency is improved.

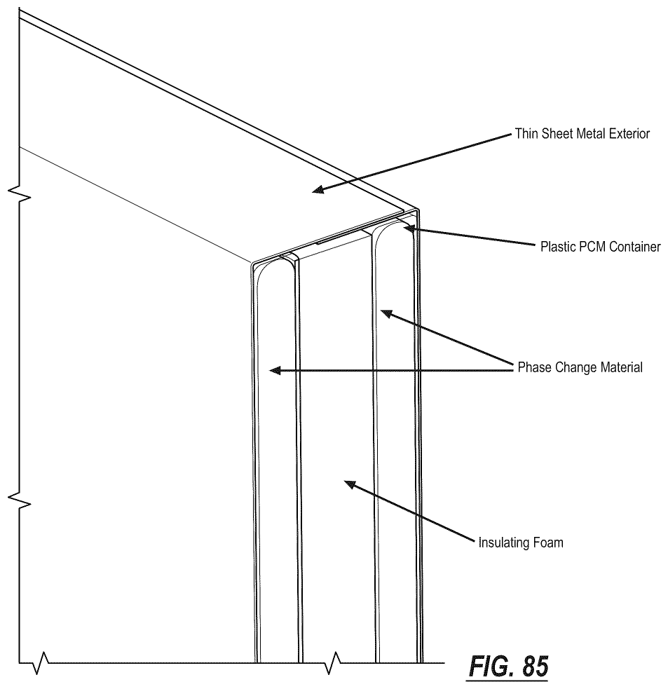

FIG. 85 schematically illustrates an insulation panel with built-in phase change materials, in accordance with some embodiments. The insulation panel may comprise a thin sheet metal exterior, a plastic PCM container containing phase change materials, and insulation foam positioned between phase change material partitions of the insulation panel. Adding phase change material to insulation panels of a pre-induction storage system allows the storage system to act as a “thermal battery.” A storage system with a large amount of thermal energy storage in PCM insulation panels can maintain a precise temperature for a long period of time with no additional energy input. This adds increased food safety robustness against power outages, equipment failures, etc. Power to the refrigeration system may also be intentionally biased towards times of the day with less expensive electricity rates.

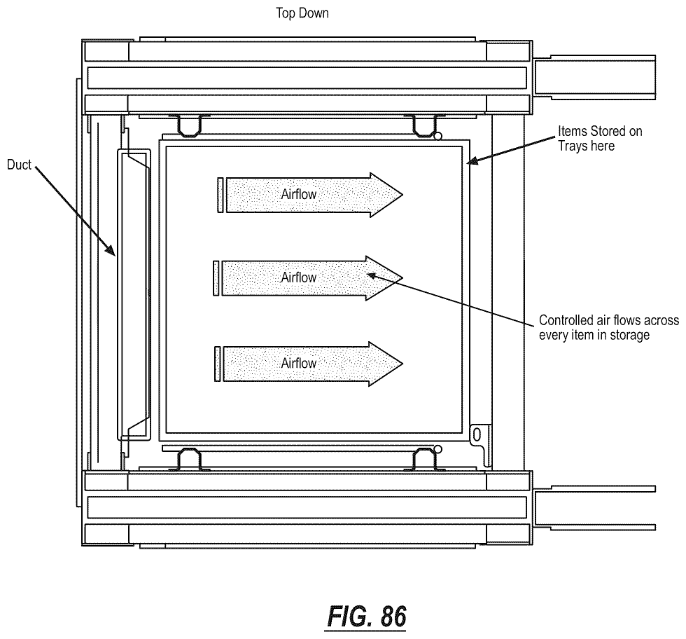

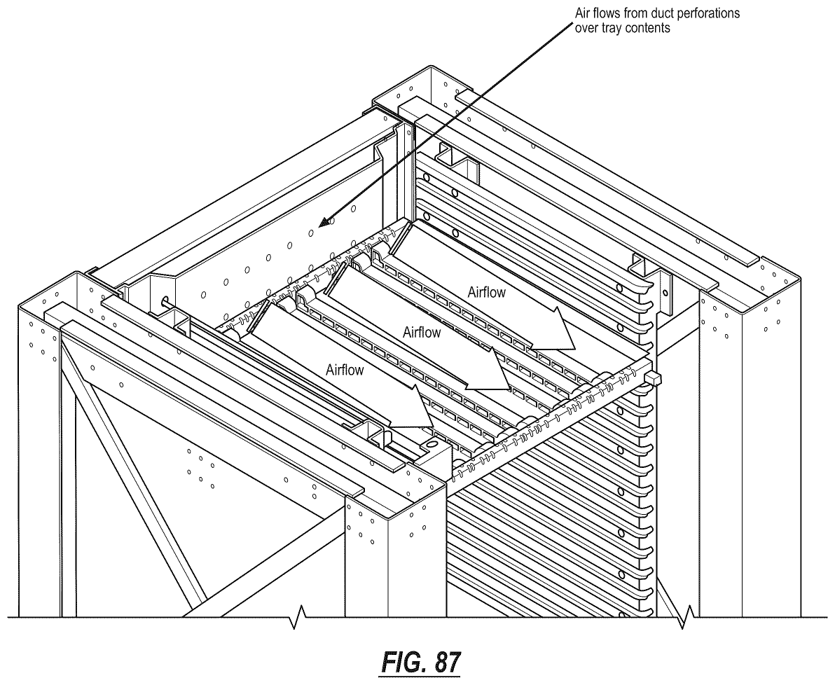

FIG. 86 and FIG. 87 schematically illustrate an integrated environmental control system, in accordance with some embodiments. The environmental control system may be integrated with an item storage system that is configured to store a plurality of items placed on a plurality of trays. The item storage system may comprise a vertical lift storage system. In some cases, the item storage system may comprise mechanics built into the structure of the item storage system to control aspects of the internal environment, including: temperature, humidity, ethylene concentration, and particulate concentration. Integrated ducting allows for even circulation of this air across all stored items, ensuring that their storage characteristics are tightly controlled. Integrated ducting allows for even distribution and tight control of environmental factors, since all items are in direct contact with controlled air flow. This leads to higher product quality standards, extended shelf lives, and better predictions of items' ripeness and freshness. Fans, refrigeration, filtration, and ethylene control elements may be mounted on top, underneath, on a wall, or in the interior of the tool and may establish airflow through the interior ducting.

### Conveyor to Bag Transport

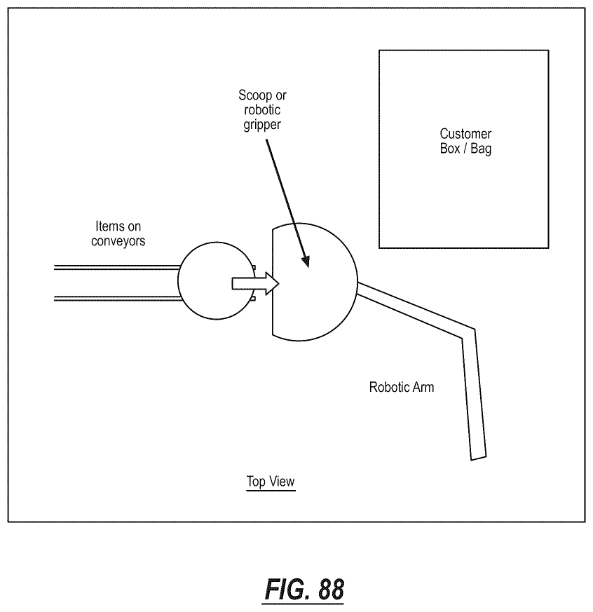

FIG. 88 schematically illustrates a robotic mechanism for transporting items from a conveyor to bag, in accordance with some embodiments. The robotic mechanism may comprise a robotic arm. In some cases, a robotic scoop may be attached to the robotic arm. The robotic scoop may be configured to receive one or more items moving along a conveyor. The robotic arm may be configured to adjust a position and/or an orientation of the scoop after one or more items are positioned within the scope. The robotic arm may lower the scoop containing the one or more items into a customer box or bag.

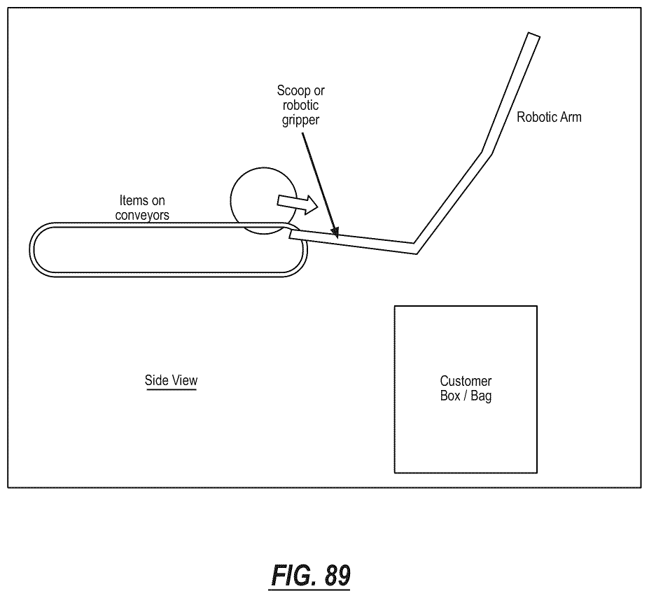

FIG. 89 schematically illustrates a robotic mechanism for transporting items from conveyor to bag, in accordance with some embodiments. The robotic mechanism may comprise a robotic arm with a scoop or robotic gripper at a distal end of the robotic arm. The robotic mechanism may be configured to receive one or more items and to move the one or more items into a customer box or bag in a controlled manner. In some cases, the items can move to the end of the conveyor and fall into a mechanism that catches or grabs the items. The mechanism may then place the items in a bag or box. Instead of dropping the items into the bag or box, the conveyor and the robotic arm are used in combination to place the items in the bag or box.

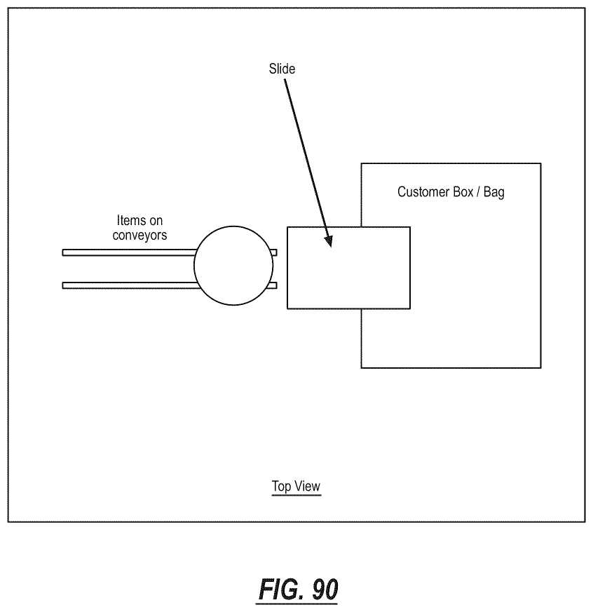

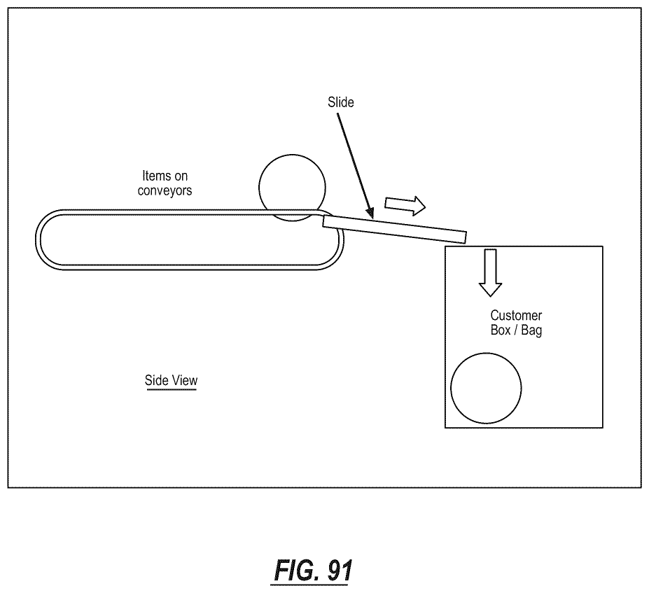

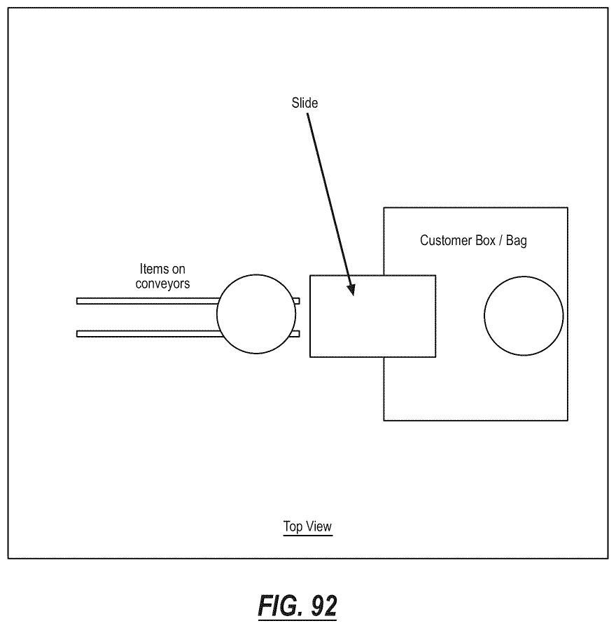

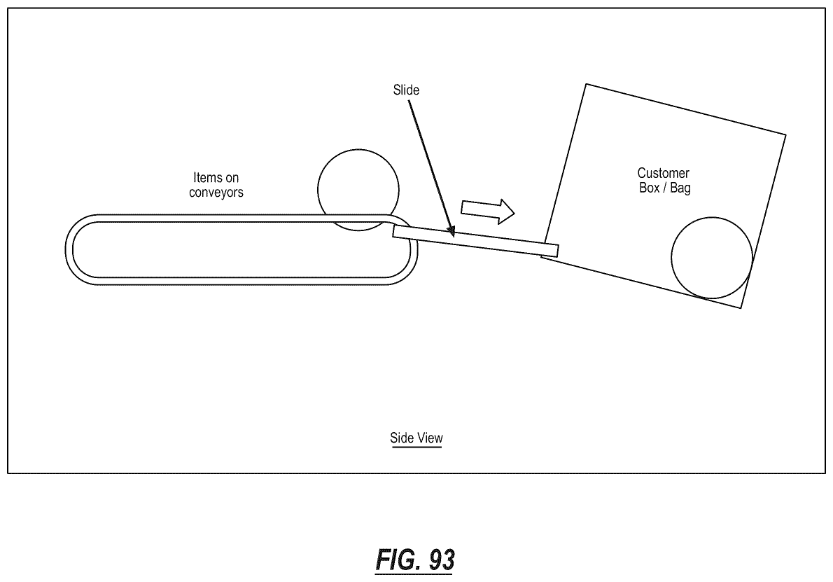

FIG. 90, FIG. 91, FIG. 92, and FIG. 93 schematically illustrate a slide into bag mechanism, in accordance with some embodiments. The slide into bag mechanism may comprise a platform on which one or more items can slide on before being dispensed in a customer box or bag. The slide can help guide the one or more items into the bag or box. The conveyors transporting the one or more items may or may not need to advance forward to allow the item to move from the conveyor to the slide. In some cases, the slide could be part of the bag or box mechanism. In other cases, the slide could be part of the conveyor system. Alternatively, the slide may be an independent tool. The slide may extend along a full length of a tray or may be the size of a lane of the tray. In some cases, the bag or box may be configured to adjust its position or orientation to receive the one or more items being dispensed or transported across the slide.

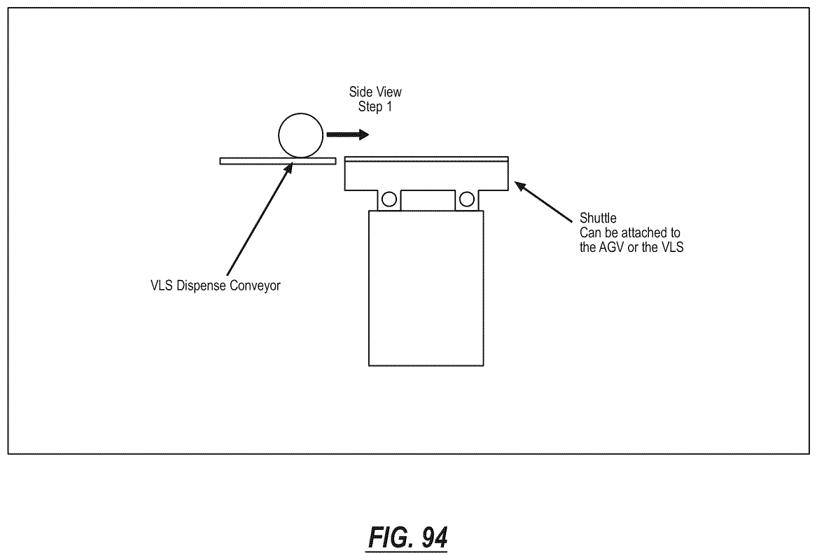

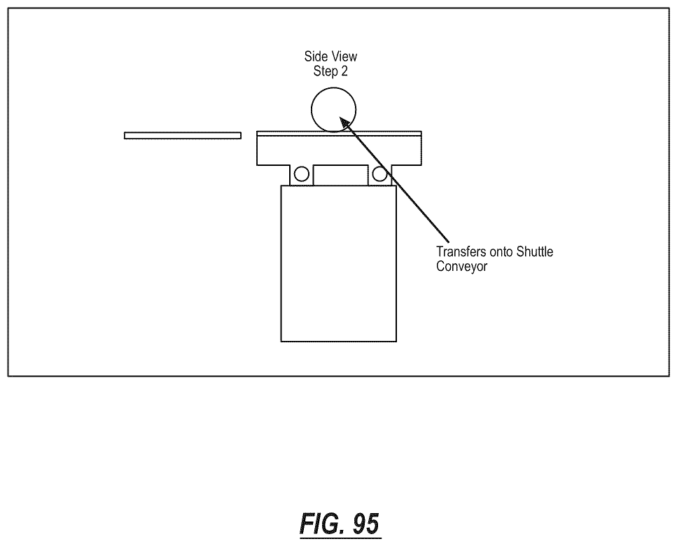

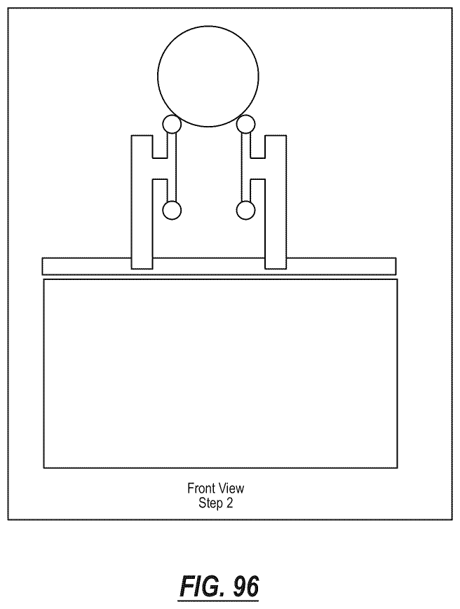

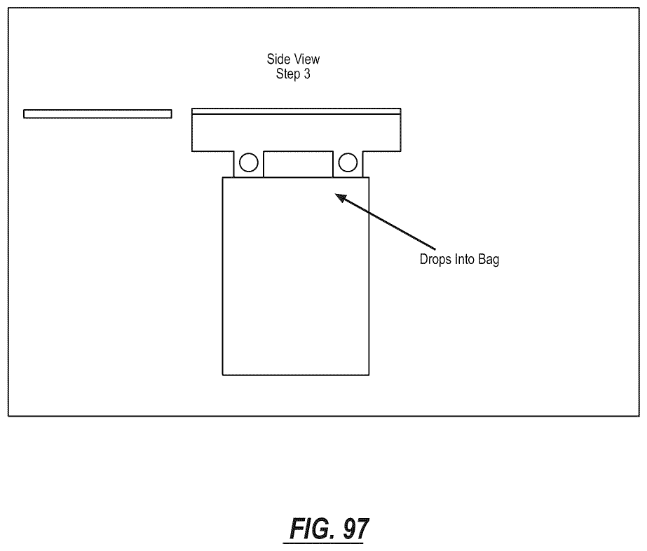

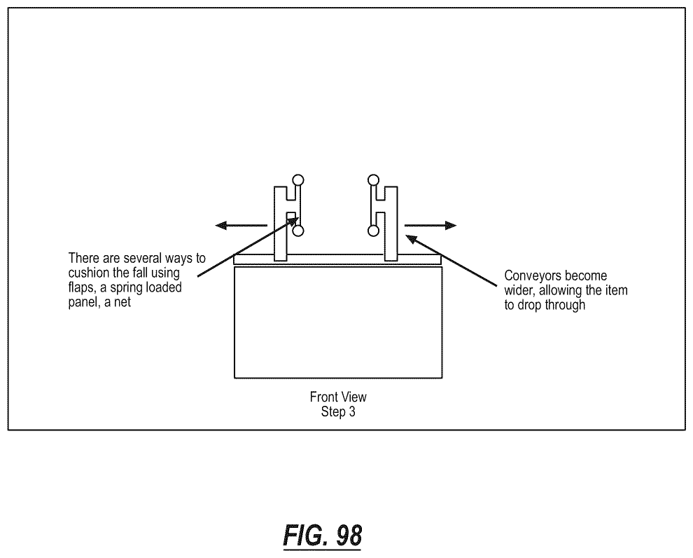

FIG. 94, FIG. 95, FIG. 96, FIG. 97, and FIG. 98 schematically illustrate an item dispense and bag handoff mechanism, in accordance with some embodiments. The dispense and bag handoff mechanism may be used to minimize damage to one or more items dropping into the bag or box since the items are never in free fall and the chances of bruising are greatly reduced. In some embodiments, a conveyor system may provide one or more items to the dispense mechanism. In some embodiments, the dispense mechanism or dispense conveyor comprises a vertical lift system (VLS). The one or more items may be transferred to a shuttle conveyor of the dispense mechanism. The shuttle conveyor may comprise two conveyors, plates, or flaps on which the one or more items may rest. The two conveyors, plates, or flaps may be configured to move apart or away from each other such that a distance between the two conveyors, plates, or flaps increases. When the distance between the two conveyors, plates, or flaps becomes greater than a dimension of the one or more items resting on the two plates, the one or more items may be dropped into a bag. In some cases, the fall of the one or more items may be cushioned using a spring-loaded panel or a net. The shuttle conveyor may be attached to the AGV or the VLS.

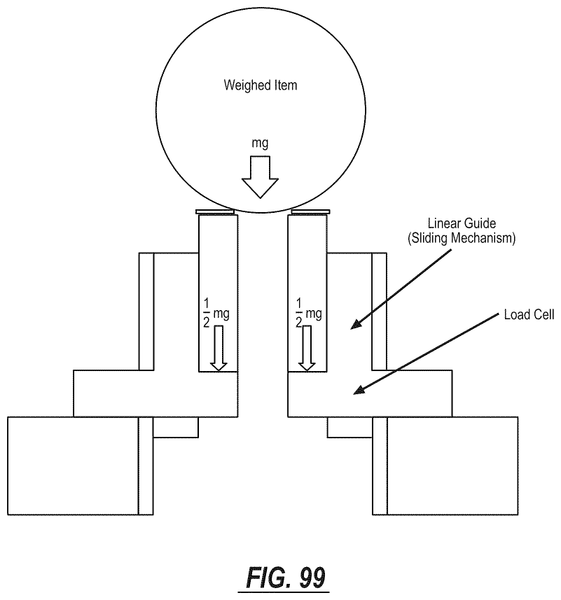

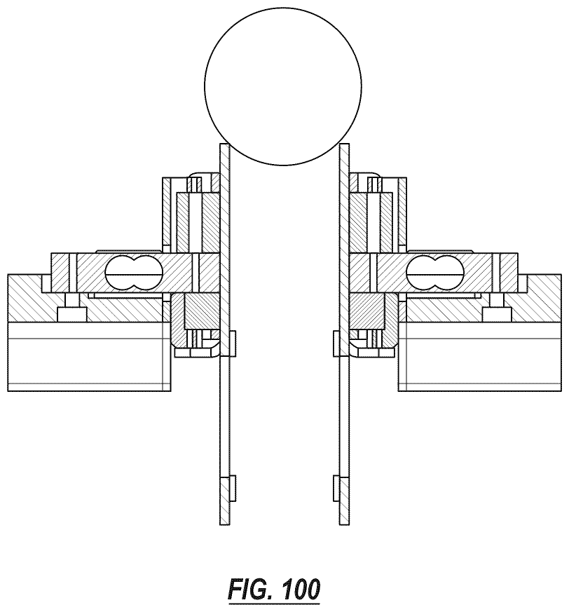

FIG. 99 and FIG. 100 schematically illustrate a mechanism for weighing objects on a conveyor belt, in accordance with some embodiments. The item being weighed may be suspended across two plates. The weighing mechanism may comprise one or more linear guides or sliding mechanisms and one or more load cells. To prevent torque and non-perpendicular forces from acting on the load cells, linear guides may be used to isolate the downward loads generated by a weight of the item being weighed. The weight of the item may be distributed across multiple load cells and summed for total weight measurement. The load cells can be positioned in different positions or orientations relative to the linear guides or the weighted item to achieve this goal.

### Computer Systems

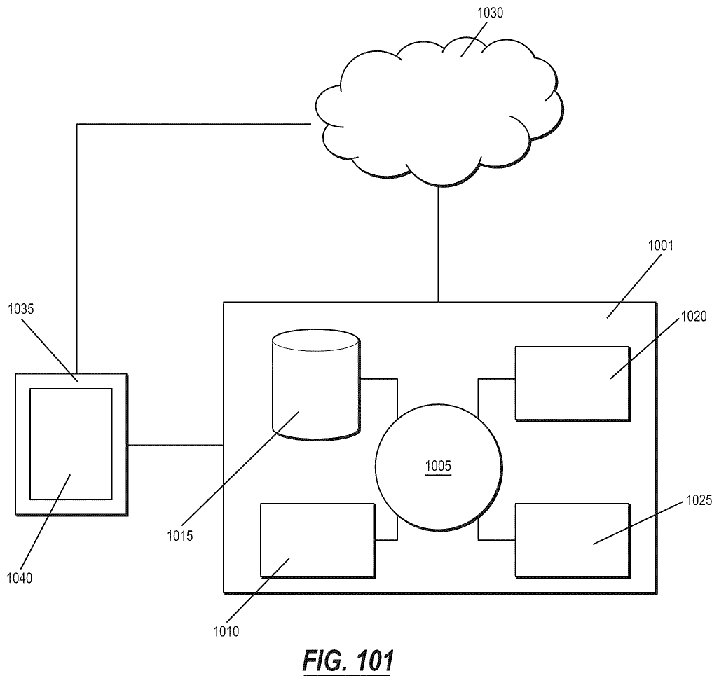

In an aspect, the present disclosure provides computer systems that are programmed or otherwise configured to implement methods of the disclosure. FIG. 101 shows a computer system XY01 that is programmed or otherwise configured to implement a method for product handling. The computer system XY01 may be configured to, for example, control a dispensing of one or more items into a container (e.g., a box or a bag). The computer system XY01 can be an electronic device of a user or a computer system that is remotely located with respect to the electronic device. The electronic device can be a mobile electronic device.

The computer system XY01 may include a central processing unit (CPU, also “processor” and “computer processor” herein) XY05, which can be a single core or multi core processor, or a plurality of processors for parallel processing. The computer system XY01 also includes memory or memory location XY10 (e.g., random-access memory, read-only memory, flash memory), electronic storage unit XY15 (e.g., hard disk), communication interface XY20 (e.g., network adapter) for communicating with one or more other systems, and peripheral devices XY25, such as cache, other memory, data storage and/or electronic display adapters. The memory XY10, storage unit XY15, interface XY20 and peripheral devices XY25 are in communication with the CPU XY05 through a communication bus (solid lines), such as a motherboard. The storage unit XY15 can be a data storage unit (or data repository) for storing data. The computer system XY01 can be operatively coupled to a computer network (“network”) XY30 with the aid of the communication interface XY20. The network XY30 can be the Internet, an internet and/or extranet, or an intranet and/or extranet that is in communication with the Internet. The network XY30 in some cases is a telecommunication and/or data network. The network XY30 can include one or more computer servers, which can enable distributed computing, such as cloud computing. The network XY30, in some cases with the aid of the computer system XY01, can implement a peer-to-peer network, which may enable devices coupled to the computer system XY01 to behave as a client or a server.

The CPU XY05 can execute a sequence of machine-readable instructions, which can be embodied in a program or software. The instructions may be stored in a memory location, such as the memory XY10. The instructions can be directed to the CPU XY05, which can subsequently program or otherwise configure the CPU XY05 to implement methods of the present disclosure. Examples of operations performed by the CPU XY05 can include fetch, decode, execute, and writeback.

The CPU XY05 can be part of a circuit, such as an integrated circuit. One or more other components of the system XY01 can be included in the circuit. In some cases, the circuit is an application specific integrated circuit (ASIC).

The storage unit XY15 can store files, such as drivers, libraries and saved programs. The storage unit XY15 can store user data, e.g., user preferences and user programs. The computer system XY01 in some cases can include one or more additional data storage units that are located external to the computer system XY01 (e.g., on a remote server that is in communication with the computer system XY01 through an intranet or the Internet).

The computer system XY01 can communicate with one or more remote computer systems through the network XY30. For instance, the computer system XY01 can communicate with a remote computer system of a user (e.g., a product handler, a grocery store, a consumer, etc.). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system XY01 via the network XY30.

Methods as described herein can be implemented by way of machine (e.g., computer processor) executable code stored on an electronic storage location of the computer system XY01, such as, for example, on the memory XY10 or electronic storage unit XY15. The machine executable or machine readable code can be provided in the form of software. During use, the code can be executed by the processor XY05. In some cases, the code can be retrieved from the storage unit XY15 and stored on the memory XY10 for ready access by the processor XY05. In some situations, the electronic storage unit XY15 can be precluded, and machine-executable instructions are stored on memory XY10.

The code can be pre-compiled and configured for use with a machine having a processor adapted to execute the code or can be compiled during runtime. The code can be supplied in a programming language that can be selected to enable the code to execute in a pre-compiled or as-compiled fashion.

Aspects of the systems and methods provided herein, such as the computer system XY01, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system XY01 can include or be in communication with an electronic display XY35 that comprises a user interface (UI) XY40 for providing, for example, a portal for a product handler or a human operator to monitor a dispensing of one or more items into a container (e.g., a customer bag or a box). The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit XY05. The algorithm can, for example, implement a method for product dispensing by controlling a movement of a dispense arm relative to a movement of a dispense belt on which one or more items are being conveyed or transported.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

I claim:

1. A method for automating order fulfillment within an order fulfillment facility comprising:
receiving a customer order specifying:
a first quantity of product units of a first product type; and
a second quantity of product units of a second product type different from the first product type;
identifying a first tray, in a population of trays, transiently storing product units of the first product type and the second product type;
assigning a dispensing unit, in a set of dispensing units, to dispense product units transiently stored in the first tray;
triggering a mobile robotic system, transiently loaded with an item container, to maneuver to a receiving area proximal the dispensing unit;
triggering the dispensing unit to dispense the first quantity of product units of the first product type, transiently stored in a first lane in a set of lanes of the first tray, into the item container; and
triggering the dispensing unit to dispense the second quantity of product units of the second product type, transiently stored in a second lane in the set of lanes of the first tray, into the item container.

2. The method of claim 1, further comprising:
identifying a first storage slot, in a set of storage slots of a tray storage rack, the first storage slot:
unassigned to a tray in the population of trays; and
exhibiting a first storage slot height compatible with a first product height of the first product type and a second product height of the second product type;
assigning the first storage slot to transiently store the first tray; and
triggering a tray routing conveyor to locate the first tray, transiently storing product units of the first product type and the second product type, in the first storage slot.

3. The method of claim 1, further comprising:
assigning the first tray to transiently store product units of the first product type and the second product type;
triggering a tray routing conveyor to locate the first tray proximal a manual loading zone in the order fulfillment facility;
generating a prompt to:
manually load product units of the first product type into the first lane of the first tray; and
manually load product units of the second product type into the second lane of the first tray; and
serving the prompt to a user.

4. The method of claim 3, further comprising:
assigning a first storage slot, in a set of storage slots of a tray storage rack, to transiently store the first tray;
triggering the tray routing conveyor to locate the first tray, loaded with product units of the first product type and the second product type, in the first storage slot; and
in response to assignment of the receiving area to the first tray:
triggering the tray routing conveyor to:
retrieve the first tray from the first storage slot transiently storing the first tray; and
locate the first tray in the dispensing unit.

5. The method of claim 1, further comprising:
triggering the mobile robotic system to maneuver to an unloading zone in the order fulfillment facility for removal of the item container, loaded with the first quantity of product units of the first product type and the second quantity of product units of the second product type, from the mobile robotic system; and
in response to removal of the item container from the mobile robotic system, triggering the mobile robotic system to:
maneuver to a delivery bay in the order fulfillment facility to retrieve a set of incoming product units; and
deliver the set of incoming product units to a manual loading zone in the order fulfillment facility for manual loading of the set of incoming product units into the population of trays

6. The method of claim 1, further comprising:
calculating a likelihood of customer orders specifying the first product type and the second product type; and
in response to the likelihood exceeding a threshold likelihood:
assigning the first lane of the first tray to transiently store a first row of product units of the first product type, the first lane exhibiting a first lane width compatible with a first product width of the first product type; and
assigning the second lane of the first tray to transiently store a second row of product units of the second product type, the second lane exhibiting a second lane width, different from the first lane width, compatible with a second product width, different from the first product width, of the second product type.

7. The method of claim 6:
wherein calculating the likelihood comprises calculating the likelihood of customer orders specifying:
the first product type comprising a boxed pasta; and
the second product type comprising a canned pasta sauce;
wherein assigning the first lane of the first tray to transiently store the first row of product units of the first product type comprises, in response to the likelihood exceeding the threshold likelihood:
assigning the first lane of the first tray to transiently store the first row of product units of the boxed pasta; and
wherein assigning the second lane of the first tray to transiently store the second row of product units of the second product type comprises, in response to the likelihood exceeding the threshold likelihood:
assigning the second lane of the first tray to transiently store the second row of product units of the canned pasta sauce.

8. The method of claim 1:
wherein triggering the dispensing unit to dispense the first quantity of product units of the first product type comprises triggering the dispensing unit to:
lift a first row of product units of the first product type, transiently stored in the first lane of the first tray, above the first lane; and
drive the first row of product units forward toward the receiving area to dispense the first quantity of product units of the first product type into the item container; and
wherein triggering the dispensing unit to dispense the second quantity of product units of the second product type comprises triggering the dispensing unit to:
lift a second row of product units of the second product type, transiently stored in the second lane of the first tray, above the second lane; and
drive the second row of product units forward toward the receiving area to dispense the second quantity of product units of the second product type into the item container.

9. The method of claim 1:
wherein triggering the dispensing unit to dispense the first quantity of product units of the first product type comprises triggering the dispensing unit to:
dispense the first quantity of product units of the first product type exhibiting a first set of product characteristics; and
wherein triggering the dispensing unit to dispense the second quantity of product units of the second product type comprises triggering the dispensing unit to:
dispense the second quantity of product units of the second product type exhibiting a second set of product characteristics, different from the first set of product characteristics.

10. The method of claim 1, further comprising:
in response to the customer order specifying product units of the first product type, identifying the first tray, in a set of unloaded trays in the population of trays, the first tray:
devoid of product units; and
exhibiting a first lane geometry compatible with a first product geometry of the first product type; and
assigning the first lane of the first tray to transiently store product units of the first product type.

11. A product handling system comprising:
a tray storage rack defining a set of storage slots, each storage slot in the set of storage slots configured to transiently store a tray in a population of trays;
a first tray in the population of trays, the first tray comprising:
a first set of supports:
defining a first set of lanes within the first tray; and
configured to support product units within the first set of lanes;
a second tray in the population of trays, the second tray comprising:
a second set of supports:
defining a second set of lanes within the second tray; and
configured to support product units within the second set of lanes; and
a controller configured to:
receive a customer order specifying:
a first quantity of product units of a first product type transiently stored in the first tray; and
a second quantity of product units of a second product type, different from the first product type, transiently stored in the second tray;
trigger a mobile robotic system, transiently loaded with an item container, to maneuver to a first dispensing unit, in a set of dispensing units, assigned to the first tray for dispensation of product units from the first tray into the item container;
trigger the first dispensing unit to dispense the first quantity of product units of the first product type into the item container;
trigger the mobile robotic system to maneuver to a second dispensing unit, in the set of dispensing units, assigned to the second tray for dispensation of product units from the second tray into the item container; and
trigger the second dispensing unit to dispense the second quantity of product units of the second product type into the item container.

12. The product handling system of claim 11, wherein the first tray is configured to:
transiently store product units of the first product type in a first lane, in the first set of lanes of the first tray, exhibiting a first lane geometry compatible with the first product type exhibiting a first set of product characteristics; and
transiently store product units of a third product type in a third lane, adjacent the first lane in the first set of lanes of the first tray, exhibiting a third lane geometry compatible with the third product type exhibiting a third set of product characteristics different from the first set of product characteristics.

13. The product handling system of claim 11, wherein the controller is further configured to:
access a first product height of the first product type;
identify a first storage slot in the set of storage slots, the first storage slot:
unassigned to a tray in the population of trays; and
exhibiting a first storage slot height compatible with the first product height of the first product type;
assign the first storage slot to transiently store the first tray;
trigger a tray routing conveyor to locate the first tray, loaded with product units of the first product type, in the first storage slot; and
in response to assignment of the first dispensing unit to the first tray:
trigger the tray routing conveyor to:
retrieve the first tray from the first storage slot transiently storing the first tray; and
locate the first tray in the first dispensing unit.

14. The product handling system of claim 11, wherein the set of storage slots:
defines a first storage slot and a second storage slot arranged above the first storage slot; and
is configured to:
in a first configuration with the first tray transiently storing product units of the first product type exhibiting a first product height:
locate the first tray in the set of storage slots with the first tray occupying the first storage slot; and
in a second configuration with the first tray transiently storing product units of the second product type exhibiting a second product height greater than the second product height:
locate the first tray in the set of storage slots with the first tray occupying the first storage slot and the second storage slot.

15. The product handling system of claim 11:
wherein, in a first configuration:
the first tray is configured to:
transiently store product units of the first product type in a first lane in the first set of lanes of the first tray, the first lane exhibiting a first lane width compatible with a first product width of the first product type; and
the second tray is configured to:
transiently store product units of the second product type in a second lane in the second set of lanes of the second tray, the second lane exhibiting a second lane width, greater than the first lane width, compatible with a second product width, greater than the first product width, of the second product type; and
wherein, in a second configuration:
the first tray is configured to:
transiently store product units of the second product type in the first lane in the first set of lanes of the first tray, the first lane exhibiting the second lane width compatible with the second product width of the second product type; and
the second tray is configured to:
transiently store product units of the first product type in the second lane in the second set of lanes of the second tray, the second lane exhibiting the first lane width compatible with the first product width of the first product type.

16. The product handling system of claim 15, wherein, in the first configuration:
the first tray is configured to:
transiently store product units of a third product type in a third lane, adjacent the first lane in the first set of lanes, the third product type:
different from the first product type; and
exhibiting a third product width, different from the first product width, compatible with a third lane width of the third lane; and
the second tray is configured to:
transiently store product units of a fourth product type in a fourth lane, adjacent the second lane in the second set of lanes, the fourth product type:
different from the second product type; and
exhibiting a fourth product width, different from the second product width, compatible with a fourth lane width of the fourth lane.

17. The product handling system of claim 11, further comprising:
the first dispensing unit configured to:
transiently receive the first tray;
lift a first row of product units of the first product type, transiently stored in a first lane in the first set of lanes of the first tray, above the first lane; and
drive the first row of product units forward toward a first receiving area occupied by the mobile robotic system to dispense the first quantity of product units of the first product type into the item container; and
the second dispensing unit configured to:
transiently receive the second tray;
lift a second row of product units of the second product type, transiently stored in a second lane in the second set of lanes of the second tray, above the second lane; and
drive the second row of product units forward toward a second receiving area occupied by the mobile robotic system to dispense the second quantity of product units of the second product type into the item container.

18. The product handling system of claim 11, wherein the controller is further configured to:
identify the first tray, in a set of unloaded trays in the population of trays, the first tray:
devoid of product units; and
exhibiting a first lane geometry compatible with a first product geometry of the first product type; and
assign a first lane, in the first set of lanes of the first tray, to transiently store product units of the first product type.

19. The product handling system of claim 11, further comprising the mobile robotic system configured to maneuver an unloading zone for removal of the item container, loaded with the first quantity of product units of the first product type and the second quantity of product units of the second product type, from the mobile robotic system.

20. The product handling system of claim 19, further comprising, a second mobile robotic system configured to:
maneuver to a delivery bay to retrieve a set of incoming product units; and
deliver the set of incoming product units to a manual loading zone for manual loading of the set of incoming product units into the population of trays.
